(19) United States
(12) Patent Application Publication
(10) Pub. No.: US 2003/0110215 A1
(43) Pub. Date: Jun. 12, 2003

(54) Apparatus and method for providing educational materials and/or related services in a network environment

(76) Inventor: Raymond Anthony Joao, Yonkers, NY (US)

Correspondence Address: RAYMOND A. JOAO, ESQ., 122 BELLEVUE PLACE, YONKERS, NY, 10703, US

(21) Appl. No.: 10/347,679

(22) Filed: Jan. 22, 2003

Related U.S. Application Data
(63) Continuation of application No. 09/515,060, filed on Feb. 28, 2000.
Application No. 09/515,060 is a continuation-in-part of application No. 08/788,387, filed on Jan. 27, 1997, now abandoned.

(51) Int. Cl. G06F 15/16; G09B 7/00

(52) U.S. Cl. 709/203; 434/362

(57) ABSTRACT

An apparatus for providing educational material in a network environment, including a processing device for processing a request from an individual to receive educational material, wherein the processing device is capable of processing information regarding the individual's progression through a course of study or a program of study, a memory device for storing educational material, a transmitter for transmitting the educational material to a communication device associated with the individual, a receiver for receiving a transmission termination signal from the communication device, wherein the processing device terminates the transmission of the educational material in response to the termination signal, and further wherein a subsequent transmission of the educational material includes a transmission of at least a portion of the educational material previously transmitted to the individual.

### RELATED APPLICATIONS

This is a continuation application of U.S. patent application Ser. No. 09/515,060, filed Feb. 28, 2000, which is a continuation-in-part application of U.S. patent application Ser. No. 08/788,387, filed Jan. 27, 1997, the subject matter of which is hereby incorporated by reference herein.

### FIELD OF THE INVENTION

The present invention pertains to an apparatus and a method for providing educational materials and/or related services, and, in particular, the present invention pertains to an apparatus and a method for providing educational materials, instruction, information, and/or related services, for and/or pertaining to courses of study, training, and/or continuing education courses, to a remote-user in a network environment.

### BACKGROUND OF THE INVENTION

The value of the recent developments of, and in, communication networks, such as the information superhighway, as mediums for transmitting and receiving vast amounts and types of information is readily appreciated. The information superhighway, the Internet, the World-Wide Web, and/or any other related and/or similar communications network and/or medium, may be utilized in a variety of ways with these entities serving to “shrink” our world as we know it. Video, audio and/or multimedia information may be freely disseminated over the Internet, the World-Wide Web and/or any other suitable communication network and/or medium so as to provide a convenient manner in which to obtain and/or exchange information via such communication networks and/or mediums.

One of the possible applications for the Internet, the World-Wide Web and/or other suitable communications networks and/or mediums is in the area of providing educational and/or instructional information over such a network and/or medium so as to allow an individual to “attend” classes and/or courses over the associated network and/or medium. Such an application may enable one to “attend” these class and/or course offerings “at” an educational and/or instructional institution from a location which is remote from the individual's location.

With various learning institutions conducting course and/or classes over the Internet, the World-Wide Web and/or other suitable mediums, it is becoming more plausible that individuals may utilize these “electronic classrooms” so as to further their educational goals, to pursue matriculating as well as non-matriculation programs of study, degree programs, certificate programs, continuing education programs, etc. As individuals become more adept to attending classes on the Internet, the World-Wide Web and/or any other suitable communication networks and/or mediums, it is foreseeable that a new area of concern will arise which relates to how an individual may attend these “classes” and/or instructional segments. Individuals may presumably “attend” classes and/or instructional segments over the Internet, the World-Wide Web and/or other suitable communication networks and/or mediums, for convenience reasons. However, even then it may not always be possible for the individual to fit the class and/or instructional segments into his or her schedule.

Further, along with any program of study, there should be at least a minimum exchange of information between the instructional institution and the individual. For example, the individual may have to take a test and/or submit homework and/or other types of assignments and/or papers. Moreover, the institution must be able to provide administration and/or monitoring over the course, class and/or program offering and the individual's activities and/or participation relating thereto.

In view of the above, there is a need for an apparatus and a method of use thereof for enabling an individual to “attend” classes and/or courses at his or her own pace and at his or her own convenience as well as to fully participate in all aspects of the educational and/or instructional process. There is also a need for an apparatus and a method for administering courses and/or programs of study on, over, and/or in conjunction with, the Internet, the World-Wide Web and/or any other suitable and/or appropriate communication network and/or medium.

### SUMMARY OF THE INVENTION

The present invention provides an apparatus and a method for overcoming the shortfalls of the prior art and provides an apparatus and method for providing educational materials and/or related services, in a network environment and, in particular, the present invention pertains to an apparatus and a method for providing educational materials, instruction, information, and/or related services, for and/or pertaining to courses of study, training, and/or continuing education courses, to a remote-user in a network environment.

The present invention provides an apparatus and a method for enabling an individual to attend classes and/or courses via the Internet, the World-Wide Web and/or via any appropriate and/or suitable communication network and/or medium, at his or her own pace. The present invention also provides an apparatus and a method for allowing an individual to enroll in, and study in, various degree programs, certificate programs, continuing education programs, etc., while providing for complete course and/or class participation and/or exchange of information and/or for providing administration over the course and/or the program.

The apparatus includes a central processing computer, a central computer system, or a server computer, and at least one, but typically a plurality of, remote user computer(s) or communication device(s). The remote user computer or communication device is connected and/or linked with the central processing computer via a communication network or medium, which may be a telecommunication and/or telephone communication network and/or any other appropriate communication network or medium. The telecommunication and/or telephone network or medium may be a line-connected communication network and/or a wireless communication network.

The communication network and/or medium may be any suitable communication system and/or network for transmitting information and/or data, including multimedia, video, and/or audio information and/or any other suitable information and/or data. Wireless communication networks and associated wireless communications devices may be utilized in conjunction with the present invention.

The central processing computer and the remote user device(s) may be equipped with communication equipment for transmitting and/or receiving the signals, data and/or information which corresponds to and/or which is associated with the utilized communication network, and/or system, and/or any combination(s) thereof.

The central processing computer includes a central processing unit, a receiver, a transmitter, a read only memory (ROM), a random access memory, a user input device(s), a display device and an output device. The central processing computer also includes a database(s), wherein various information and/or data is stored and which is also connected to, and accessible by, the CPU. Various educational and/or instructional material and/or data and/or information is stored in the database. The educational and/or instructional material and/or data and/or information, may include taped and/or pre-recorded multimedia, video and/or audio instruction sessions which provides multimedia, video, and/or audio material for presentation to a user or student. The educational and/or instructional material may be multimedia, video and/or audio-taped instructional classes, lectures, and/or segments which can be in the form of multimedia, video and/or audio presentations. The educational and/or instructional material may employ graphics and/or sound so that the user or student may derive optimal benefits from the presentation.

The educational and/or instructional materials can include video materials, audio materials, and/or audio and video material (audio-visual materials), text materials, images, graphics, and/or any other form or type of materials.

The data and/or information which is stored in the database(s) may also include course and/or degree program and/or certificate program data and/or requirements, continuing education requirements, administrative and/or other institution and/or course management data and/or information, etc. The database(s) may contain student announcements for the remote user or student. The data and/or information stored in the database(s) may also contain any and all data and/or information, including data and information pertaining to the user(s), student(s), instructor(s), administrators, etc. The database(s) may also include data and/or information pertaining to course and/or program management, including data and/or information for monitoring a user(s) and/or a student(s) progress and/or progression through a course and/or program.

The database(s) may also include, and/or be linked to other database(s), which includes courses and/or text materials, such as textbook(s) and/or coursebook(s) material, outside and/or required and/or supplemental materials and/or data or information, and/or presentations, and/or reserved reading and/or instructional materials, such as materials which may usually be placed on reserve in an institutional library by an instructor. The database(s) may be both internal to the central processing computer and/or the database(s) may be external databases, such as for example, a specialized and/or designated on-line service or system database, which may be accessed by the central processing computer and/or by the remote user device.

The central processing computer may also comprise a monitoring device which may be connected to the CPU and/or to the databases. The monitoring device may serve to monitor a users and/or a students accessing of the various data and/or information from the database, including the users and/or students viewing of the instructional information presentation and/or segments. The monitoring device may also monitor and/or keep track of the amount of data and/or information which is transmitted to the remote user device for a given user, student and/or other individual. The central processing computer can also include a video recording device and an audio recording device for facilitating video conferencing by and between any of the parties described herein as utilizing the present invention.

The data and/or information, and in particular, the course and/or instructional material, may be time encoded and/or digitally and/or otherwise encoded, or marked, so that the monitoring device, and therefore, the central processing computer, may record and maintain a record of the materials, information and/or data and/or any amount thereof, which is, or which has been, transmitted to a given remote user device during, or for, a given period and/or periods. The method and/or manner of encoding the course materials may be any one and/or any combination of those conventional encoding and/or marking methods and/or techniques which are known by those skilled in the art as of the filing date of this application. In this manner, the monitoring device may monitor and record the start and stop locations in the presented material, information and/or data for a given transmission to a given remote user device so as to monitor the user's and/or student's progression through the materials.

In a situation where a user and/or a student wishes to view a lecture and/or a presentation, the monitoring device will record the start location of the lecture or presentation. When the user or student wishes to end the viewing of the lecture or presentation, or portion thereof, the monitoring device will then record the stop location of the lecture or presentation.

The monitoring device may be utilized to monitor and/or record a user's and/or student's progression and/or viewing for all of the possible information which is accessible to the user or student from the apparatus for a given course or courses of instruction. In this manner, the user or student may view and/or progress through a course and/or presentation at his or her own pace, via the remote user device. The student may also access all database materials, i.e. text materials, test materials, research materials, reserved and/or extra reading materials, and progress through same in the manner described above wherein progression may be monitored and/or recorded by and/or at the central processing computer and/or at the remote user device.

The user's or student's progression through the information, the start and stop data, and/or other progression data, may also be available to the user or student so that the user or student may keep track of same so as to monitor his or her own progression. This data may be stored in the remote user device and/or be retrieved from the central processing computer.

The apparatus may also be equipped so as to enable a user or student to re-view lectures, course presentations, and/or other database materials available, via the central processing computer. In this regard, the encoded course presentation and/or other materials will be available to the user or student at any time. The user or student need only input the codes representing the lectures and/or presentations, or portions thereof, and/or the relevant start location code(s) corresponding to the material or information which he or she wishes to view or re-view. The user or student may view or re-view any lectures and/or materials, and/or any portions thereof, at any time during the course offering or availability, semester, trimester, etc.

The database contains data and/or information for the course lectures, text materials, reserved materials, research materials, test materials, student records, administration and/or institutional records, degree and/or other program requirements and offerings related thereto. All of the above data, information and materials may be in any one or more of a multimedia, audio, video and/or text format and/or may be in any other suitable format which is consistent for presentation over a communications network and/or medium environment.

The lecture and/or course presentation materials, and/or other presentation materials, can and/or may be provided in a multimedia format, where appropriate, so that a multimedia presentation may be available to the user or student. The materials and/or presentations, where appropriate, may also be available in split screen or multiple screen format so that the lecture and/or course presentation may also include a view of the lecturer as well as a visual presentation medium such as a blackboard, illustrative pictures, etc and/or any other course related or program related materials or other suitable materials. Such a multiple screen presentation may assist the user or student in understanding the presentation and/or for facilitating ease of note-taking. In this regard, a blackboard containing notes may also be presented in the split screen format.

The apparatus and method of the present invention may also be utilized in conjunction with live broadcasts of classes and/or other educational and/or instructional presentations. In this regard, the central processing computer may receive the broadcast data and or information via the receiver. The central processing computer may also have a recording device associated therewith for recording live broadcasts and/or presentations, for storage and for later presentation, in the database. Such a recording device may include a compact disk recording device for recording information onto a compact disk, or a video recording device such as for recording information on a video tape. Other appropriate recording devices and/or mediums may also be employed.

Any and all of the taped and/or pre-recorded educational and/or instructional materials and/or presentations, and/or administrative announcements, and/or the reserved and/or supplemental materials and/or any other data and/or information which is provided to, and/or which may be made available and/or accessible to the user or student, in the preferred embodiment, may be encoded and/or marked, digitally, time-wise, and/or otherwise, by any other appropriate manner, and by techniques which are well known in the art, so that the central processing computer and the user or student may record and/or store the user's or student's point of progression through the materials and/or presentations. This progression data may be stored at the central processing computer in a database of student accounts as well as be saved in the remote user device of the user or student. In this manner, a student may progress through the course and/or materials, and/or review materials, at his or her convenience and/or at his or her own pace.

The apparatus may also monitor the dissemination of the materials to the student, such as in instances when a user's or student's review or reception of the materials may be necessary and/or required. The sever computer as well as the remote user device may be equipped to monitor progression through these materials and, therefore, can be equipped so as to store the information relative to these markings on the taped materials. In this manner, the central processing computer as well as the user or student will have the user's or student's progression data available at all times.

The educational and/or instructional classes and/or presentations may also be transmitted live, via the apparatus, to the student. In this regard, the apparatus may also comprise an instructional broadcasting device which may be utilized in conjunction with the central processing computer. The broadcasting device may also be connected to the CPU so that its operation may be controlled and/or be monitored.

The remote user device includes a central processing unit, a receiver, a transmitter, a read only memory, a random access memory, a user input device, a display device and an output device. The remote user device also includes a database(s), wherein the various educational and/or instructional materials, information and/or data which corresponds to the user's or student's studies and/or related data and/or information, may be stored.

The database(s) may also have course, materials and/or information, and/or degree program and/or certificate program data and/or requirements, as well as administrative and/or other data and/or information pertinent to the program and/or to the user(s) and/or student(s). The database(s) may also contain any and all data and/or information, including data and information pertaining to the user(s), student(s), instructor(s), administrators, etc. The database(s) may also include data and/or information pertaining to course and/or program management, including data and/or information for monitoring a user's and/or student's progress and/or progression through a course or program. In this regard, the start and stop location data, which keeps track of and/or monitors the user or student progression though the materials and/or presentations, may be stored in the database.

The database(s) may also include and/or be linked to an external database(s) (not shown) which may include course or text materials, such as the full or partial text of textbooks and/or coursebooks, outside and/or supplemental reading and/or instructional materials, such as materials usually placed on reserve in a library by an instructor. The database(s), may be both internal to the remote user device and/or may be external to the remote user device, and which may include a specialized and/or designated on-line service or system database, which may be accessed by the user remote device and/or by the central processing computer.

The remote user device may also comprise a multimedia recording device for recording any of the materials and/or information made available to the user or student via the central processing computer and/or the apparatus. The recording device may be a compact disc recording device, a video recorder and/or any other suitable recording device, for recording a multimedia and/or other presentation.

The remote user device can also include a monitoring device for monitoring user or student progression through course materials. The remote user device can also include a video recording device and an audio recording device for facilitating video conferencing by and between any of the parties described herein as utilizing the present invention.

Data and/or information is freely exchangeable and/or transferable between the central processing computer and the remote user device. In this regard, all educational and/or instructional materials and/or presentations, textbook and/or other coursebooks and/or course materials, reserve and/or other supplemental course materials, institutional and/or administrative announcements, tests and/or examinations, etc. may be transferred from the central processing computer to the remote user device. Completed assignments, completed tests and/or examinations, questions and/or inquiries to an instructor, etc., may also be transferred from the remote user device to the central processing computer.

The present invention provides an apparatus for enabling a user or student to attend, and/or participate in, an educational environment, as if he were attending classes or courses at an education institution, and further, the present invention provides an apparatus and a method for allowing the user or student to attend, view and/or re-view these presentations at his or her own pace.

The database of the central processing computer can also include educational and/or instructional material, and/or segments thereof, which can be provided by or from different instructional sources, schools, and/or educational institutions. The educational and/or instructional materials can be encoded and/or marked, digitally and/or otherwise, time-marked and/or time-stamped, and/or can be numbered and/or otherwise trackable and/or countable so as to facilitate being able to monitor the student's progression through same.

The central processing computer can record and store respective stop locations in the educational and/or instructional materials and can determine and/or compute a start location, in the educational and/or instructional materials, from which a subsequent session and/or transmission of the educational and/or instructional materials to the student will commence. The central processing computer will determine or compute a start location in the educational and/or instructional materials so that the start location will include a review or refresher of at some of the materials previously viewed and/or received by the user or student.

The start location will be determined and/or be calculated so as to be a location in the educational and/or instructional materials which is prior to the stop location, in the educational and/or instructional materials, so as to provide a certain amount of review for the student, of the educational and/or instructional materials previously received by the user or student, prior to reaching and continuing from the previously stored stop location.

The user or student may select or pre-select, and/or change, and/or dictate, the amount of the review and/or overlap in the educational and/or instructional materials, at any time, including, but not limited to the time of each accessing of the materials, at the time of the student's registration in the respective course or program, at the time of a termination of a session, and/or at any other time. The administrator of the central processing computer and/or the educational institution offering the course or program can also select or dictate the amount of review and/or overlap.

The apparatus and method of the present invention can be utilized to provide monitoring of a student's progression through the educational and/or instructional materials by a third party such as, but not limited to, an instructor, an administrator, an employer, a supervisor, and/or any other third party who or which may have an interest in monitoring the student's progression through the educational materials and/or instructional materials, and/or any portion and/or segment of a course or program.

The central processing computer may monitor the user's or student's viewing and/or progression of, and through, the course materials, so as to monitor and/or to record the user's and/or student's progress, i.e. what the user and/or student has viewed, so as to monitor and/or record user and/or student progression through the course and/or presentation materials. The central processing computer may also be capable of allowing the user and/or student to re-view and/or replay any portions of any classes, courses and/or presentational materials.

The central processing computer may transmit text materials, supplementary materials, notes, institutional and/or administrative announcements, research materials and/or test and/or examination materials, to the remote user device, which materials may be down-loaded by the user and/or student at the remote user device, whereat the information and/or materials may be stored on an appropriate storage device, such as a hard disk, a diskette, a floppy disk and/or a compact disk and/or any other appropriate storage device and/or medium. The material may be viewed on the display monitor and/or may printed out on a printer.

The apparatus and method of the present invention facilitates on-line and/or network dissemination of educational and/or instructional materials and/or information so as to allow an individual to attend or participate in classes and/or courses of instruction, from a remote location and/or on, or over, a network environment, such as on, or over, the Internet, the World Wide Web, and/or any other suitable communication and/or network environment. The present invention provides an apparatus and method whereby a user or student may view instructional and/or educational material at his or her own pace. The apparatus also monitors and keeps track of the individual's progression through the course or material.

The apparatus and method of the present invention may also be utilized for user or student research purposes and/or for providing the user or student with the opportunity to obtain information related to the course or courses from any and all of the file databases which are or can be associated and/or which correspond to the course or materials.

In this regard, the present invention provides an apparatus and a method for providing educational and/or instructional materials to the user or student at a remote location. Further, the user or student may progress through the information and/or course materials at his or her own pace. The present invention also provides the user or student with the ability to obtain textbook and/or coursebook materials, reserved and/or supplementary reading and/or other materials, and/or to allow the user or student to perform course-related research and/or searching so as to obtain needed and/or desired information and/or materials for use in conjunction with the coursework.

The present invention provides an apparatus and a method by which a user or student may progress through coursework at his or her own pace and from a remote location. The student may also review the instructional segments as many times as is desired and may also obtain all necessary materials, course materials, reserved reading and/or supplemental materials, via the apparatus.

The present invention may be utilized to provide continuing education updates and/or developments, for any given field of knowledge and/or field of study, on a periodic basis. The updates and/or information, in the preferred embodiment, however, may be transmitted to and/or stored in a database associated with, and/or which constitutes part of, the database of the central processing computer and/or remote user device. The individual can be notified of the presence, and/or the occurrence, of the updates upon signing on and/or logging onto the apparatus and, thereafter, receive the updates and/or information via the remote user device.

The present invention also provides the means by which the user or student may take a test or examination online, download the test or examination, and/or retransmit a completed test or examination, on-line, to the central processing computer and/or to a designated location so as to enable the administration of the complete course requirements in conjunction with the apparatus.

The apparatus of the present invention can also be utilized to perform course administration and for administering the presentation of course and/or instructional materials and for monitoring the user's and/or student's fulfillment of course requirements in an educational and/or an instructional environment.

The apparatus and method of the present invention may also be utilized so as to administer and/or monitor a user's and/or a student's progress through a degree program, a certificate program, a continuing education program and/or other educational or similar environment.

The present invention the apparatus may provide announcements and/or communicate with the student at times and/or locations when and where the student is not connected to the central processing computer. In this regard, the apparatus may be utilized so as to communicate with the student such as, for example, by notifying the student of administrative-related and/or course-related announcements, course scheduling information, testing information, assignment information, registration information and/or any other information related to the course and/or program of study.

Any of the instructors, educators, and/or administrators, can have remote user devices associated therewith for use in conjunction with the apparatus.

The central processing computer and/or the remote user devices can also be equipped with video conferencing equipment so as to facilitate video conferencing between any of the parties described herein as being able to utilize the present invention. The apparatus and method of the present invention can provide all of the services amenities of an educational institution in a virtual environment and/or in a distance learning environment.

The central processing computer can provide in, its respective database, various course or program requirements for any and/or all of the various programs and/or educational institutions offering courses and/or programs of study via the present invention. The database can also provide alternate, equivalent and/or substitute lectures, course segments, and/or other educational and/or instructional materials which are approved to be equivalent to and/or which can be substituted for any of the respective lectures, course segments, and/or other educational and/or instructional materials, offered by an institution. The student may at any time access and view and/or otherwise participate in any of these alternate and/or substitute lectures, course segments, and/or other educational and/or instructional materials during the course or program of study for which he or she is currently enrolled.

A student taking a course can substitute a lecture on a particular topic with an equivalently deemed lecture from another course offered by the student's educational institution and/or another educational institution. In this manner, the student of students can partake in obtaining and/or participating in lectures, course segments and/or other educational and/or instructional materials offered by other instructors and/or other educational institutions while not interrupting his or her studies and/or current courses and/or programs. In this manner, the present invention can also provide for a more versatile courses and/or program offerings.

The present invention can also provide information regarding alternatives, equivalents and/or substitutes, for any complete courses which can be accepted for transfer credit by the student's educational institution. The database of the central processing computer can store any and/or all information regarding the educational institutions, the courses offered thereby, the courses of other educational institutions for which transfer credits will be accepted as well as any other information needed and or desired for providing and/or for facilitating these services.

The apparatus of the present invention can provide notification services to students when a specific course or lecture, whether acceptable for transfer credit, or as an equivalent or substitute lecture, or not, may be offered by a particular educational institution or by a particular professor or educator.

The apparatus and method of the present invention can facilitate distance learning by a student or students at different educational institutions and/or with different instructors during a course, a course of study, and/or a program of study. The present invention can also provide for a distance learning environment wherein the student may choose from a large variety and/or selection of courses, lectures and/or programs, from any number and/or types of educational institutions, training facilities and/or schools.

The apparatus and method of the present invention can facilitate any and/or all student registration for any and/or all of the courses, lectures, educational and/or instructional segments and/or any and/or all of the educational and/or instructional materials, provided by and/or via the apparatus. The apparatus can also provide all record keeping functions regarding any and/or all use of the present invention by any of the respective educators, instructors, administrators and student who utilize the present invention.

The apparatus can administer financial accounts for any of the educational institutions, students, instructors, administrators, and or other users of the present invention.

The present invention can be utilized in conjunction with distance learning and on-line educational and/or instructional programs, employee training programs, job training programs, vocational programs, continuing education programs, as well as in any other instances where an individual and/or individuals may simply want to enroll in courses for personal enjoyment, interest and/or professional growth.

In another preferred embodiment, the apparatus 100 can be utilized in conjunction with search engines and/or with a meta search engine(s) in order to locate or find courses, educational institutions, research, instructors, experts, tutors, and/or services and/or products related to any of the educational services and/or products described herein and/or related thereto.

The apparatus and method of the present invention can also be utilized in conjunction with intelligent agents, software agents, mobile agents, and/or related technologies which agents can be utilized and/or can be programmed and/or designed to act on behalf of the respective users, students, administrators, instructors, and/or educational institutions.

The central processing computer can have courses stored in the database. The courses can be encoded, marked, time-marked, time-stamped, frame numbered, and/or otherwise encoded and/or marked in any of the manners described herein and/or any other suitable manner and/or fashion, so as to present to the user or student with a table of contents or syllabus for allowing the user or student to access and obtain any course materials, or portions thereof, at any time.

The user or student may, in this manner, access and/or obtain any information from any of the courses, or portions thereof, in any order he or she desires. The central processing computer can monitor and record the user's or student's usage of and/or accessing of any of the course materials and/or portions thereof.

Accordingly, it is an object of the present invention to provide an apparatus and method for providing educational materials and/or related services.

It is another object of the present invention to provide an apparatus and a method for providing educational materials and/or related information in a network environment.

It is still another object of the present invention to provide an apparatus and a method for providing educational materials which provides for the monitoring of an individual's progress through the materials.

It is yet another object of the present invention to provide an apparatus and a method for providing educational materials which records a stop location or stop position in the materials, where the individual terminates an educational and/or instructional session, and which determines or computes a start location or start position in the materials from which a subsequent educational and/or instruction session can begin.

It is another object of the present invention to provide an apparatus and a method for providing educational materials which monitors an individual's progress through the materials and which records a stop location or stop position in the materials, where the individual terminates an educational and/or instructional session, and which determines or computes a start location or start position in the materials from which a subsequent educational and/or instruction session can begin.

It is still another object of the present invention to provide an apparatus and a method for providing educational materials which provides an individual with a review or refresher of materials previously viewed prior to providing new materials to said individual.

It is still another object of the present invention to provide an apparatus and a method for providing educational materials which provides an individual with a review or refresher of materials previously viewed prior to providing new materials to said individual, in a network environment.

It is another object of the present invention to provide an apparatus and a method for providing educational materials and/or related information to individuals and/or groups of individuals in conjunction with an on-line service, and/or on, or over, a communication network or environment, including the Internet and/or the World Wide Web and/or any other suitable communication network or environment.

It is yet another object of the present invention to provide an apparatus and method for providing educational materials and/or related information which enables an individual or group of individuals to pursue a course or program of study, to matriculate in a degree program, a certificate program, to participate in a continuing education program, and/or to engage in any other program(s) of study, at his, her or their own pace and from a location remote from the educational institution.

It is another object of the present invention to provide an apparatus and a method for providing educational materials and/or related information which enables an individual or group of individuals to enroll in, to participate in, and to partake in, educational and/or instructional programs of study, at any time and from any location and which further enables an individual or group of individuals to study at a plurality of institutions at the same time.

It is still another object of the present invention to provide the an apparatus and a method for providing educational materials and/or related information which allows an individual or group of individuals to enroll in and/or to partake of educational and/or instructional courses and programs, at their own pace, while allowing these individuals to progress through courses and/or instructional sessions in a network communication environment.

It is yet another object of the present invention to provide an apparatus and a method for providing educational materials and/or related information and which allows an individual or group of individuals to fulfill various course and/or program requirements in conjunction therewith in a network communication environment.

It is another object of the present invention to provide an apparatus and a method for providing educational materials and/or related information which allows an individual or groups of individuals to participate in various programs of study and/or to fulfill requirements associated therewith in a network communication environment.

It is still another object of the present invention to provide an apparatus and a method for providing the educational materials and/or related information which provides for the administration and/or the monitoring of a course and/or class presentation in a communication network environment and which can also provide for the monitoring of an individual's progression through a course and/or program of study and/or the individual's satisfaction and/or fulfillment of requirements associated therewith.

It is yet another object of the present invention to provide an apparatus and a method for providing educational material and/or related information and/or services which can utilize educational and/or instructional materials which are encoded and/or marked, digitally and/or otherwise, time-marked and/or time-stamped, and/or which can be numbered and/or otherwise trackable and/or countable so as to facilitate the monitoring of a user's or a student's progression through same.

It is another object of the present invention to provide an apparatus and a method for providing educational material and/or related information and/or services which can provide video materials, audio materials, and/or audio and video material (audio-visual materials), text materials, images, graphics, and/or any other form or type of materials.

It is still another object of the present invention to provide an apparatus and a method for providing educational material and/or related information and/or services which can provide video conferencing between any of the respective parties who or which utilize the present invention.

It is yet another object of the present invention to provide an apparatus and a method for providing educational material and/or related information and/or services which can provide for a review or refresher period or segment in the educational and/or instructional materials prior to transmitting new materials to the user or student.

It is another object of the present invention to provide an apparatus and a method for providing educational material and/or related information and/or services which provides for a customized selection of a review or refresher period or segment in the materials prior to viewing new material in a current session.

It is still another object of the present invention to provide an apparatus and a method for providing educational material and/or related information and/or services which can provide monitoring of a student's progression through the educational and/or instructional materials by a third party.

It is yet another object of the present invention to provide an apparatus and a method for providing educational material and/or related information and/or services which can be provide all of the services and/or amenities of an educational institution in a virtual environment and/or in a distance learning environment.

It is another object of the present invention to provide an apparatus and a method for providing educational material and/or related information and/or services which can be provide notification services to students when a specific course or lecture may be offered by a particular educational institution or by a particular professor or educator.

It is still another object of the present invention to provide an apparatus and a method for providing educational material and/or related information and/or services which can facilitate distance learning by a student or students at different educational institutions and/or with different instructors during a course, a course of study, and/or a program of study.

It is yet another object of the present invention to provide an apparatus and a method for providing educational material and/or related information and/or services which can be can facilitate student registration for any and/or all of the courses, lectures, educational and/or instructional segments and/or any and/or all of the educational and/or instructional materials, provided by and/or via the apparatus.

It is another object of the present invention to provide an apparatus and a method for providing educational material and/or related information and/or services which can administer and/or manage financial accounts for any of the educational institutions, students, instructors, administrators, and or other users of the present invention.

It is still another object of the present invention to provide an apparatus and a method for providing educational material and/or related information and/or services which can be utilized in conjunction with distance learning and on-line educational and/or instructional programs, employee training programs, job training programs, vocational programs, continuing education programs, as well as in any other instances where an individual and/or individuals may simply want to enroll in courses for personal enjoyment, interest and/or professional growth.

It is yet another object of the present invention to provide an apparatus and a method for providing educational material and/or related information and/or services which can be utilized in conjunction with search engines and/or with a meta search engine(s) to locate or find courses, educational institutions, research, instructors, experts, tutors, and/or services and/or products related to any of the educational services and/or products described herein and/or related thereto.

It is another object of the present invention to provide an apparatus and a method for providing educational material and/or related information and/or services which can be utilized in conjunction with intelligent agents, software agents, mobile agents, and/or related technologies.

It is still another object of the present invention to provide an apparatus and a method for providing educational material and/or related information and/or services which can be facilitate a user or student accessing and/or obtain any information from any of the courses, or portions thereof, in any order he or she desires.

Other objects and advantages of the present invention will be apparent to those individuals skilled in the art upon a review of the Description Of The Preferred Embodiment taken in conjunction with the Drawings which follow.

### BRIEF DESCRIPTION OF THE DRAWINGS

In the Drawings:

FIG. 1 illustrates a block diagram of the apparatus which is the subject of the present invention;

FIG. 2 illustrates a block diagram of the central processing computer of FIG. 1;

FIG. 3 illustrates a block diagram of the user remote device of FIG. 1;

FIGS. 4A and 4B illustrate a flow diagram illustrating a preferred embodiment operation of the apparatus and method of the present invention;

FIGS. 5A and 5B illustrate a flow diagram illustrating an operation of the apparatus and method of the present invention as it is utilized to perform and/or to provide course management and/or administrative functions;

FIG. 6 illustrates a flow diagram illustrating an operation of the apparatus and method of the present invention in administering a program of study; and

FIG. 7 illustrates an another preferred embodiment of the apparatus of the present invention.

### DESCRIPTION OF THE PREFERRED EMBODIMENT

The present invention pertains to an apparatus and a method for providing educational materials and/or related services, in a network environment and, in particular, the present invention pertains to an apparatus and a method for providing educational materials, instruction, information, and/or related services, for and/or pertaining to courses of study, training, and/or continuing education courses, to a remote-user in a network environment.

The present invention provides an apparatus and a method for enabling an individual to attend classes and/or courses via the Internet, the World-Wide Web and/or via any appropriate and/or suitable communication network and/or medium, at his or her own pace. The present invention also provides an apparatus and a method for allowing an individual to enroll in, and study in, various degree programs, certificate programs, continuing education programs, etc., while providing for complete course and/or class participation and/or exchange of information and/or for providing administration over the course and/or the program.

Applicant hereby incorporates by reference herein the subject matter and teachings of U.S. patent application Ser. No. 08/788,387, filed Jan. 27, 1997, from which application priority is claimed.

As utilized herein, the terms “individual”, “student”, or “user”, or the plurals thereof, can be used interchangeably and can refer to any individual, individuals, student, students, user and/or users, who or which utilize the present invention in order to receive and/or to utilize any of the educational and/or instructional materials described herein and/or who or which utilize any of the apparatuses, devices, methods and/or services, described herein.

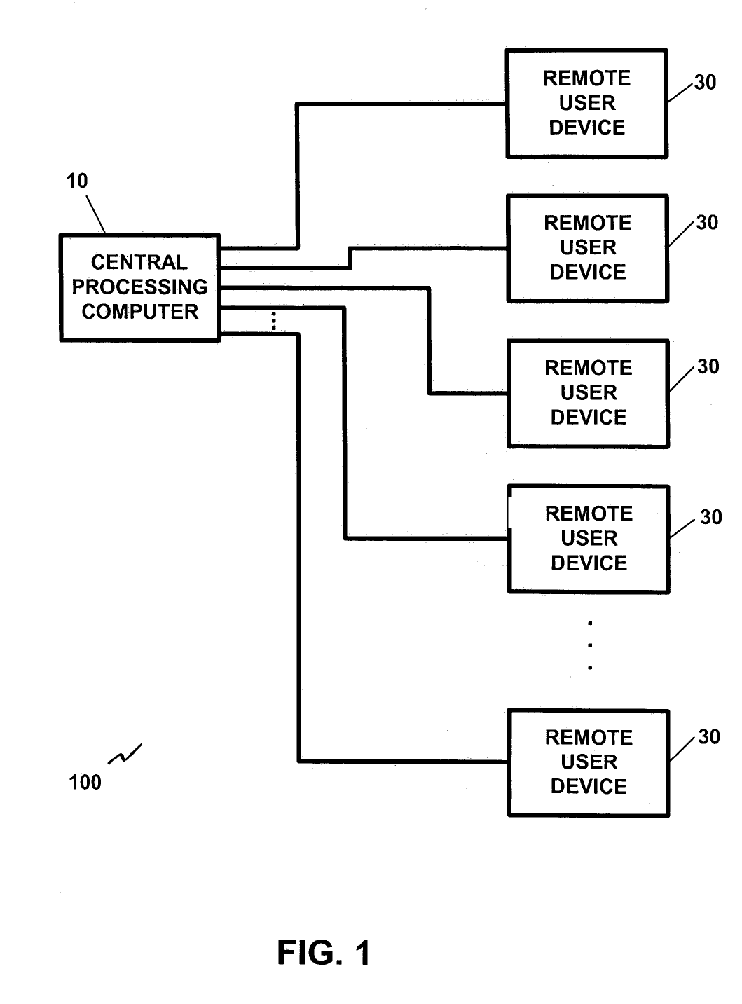

FIG. 1 illustrates a block diagram of the apparatus which is the subject of the present invention and which is denoted generally by the reference numeral 100. As illustrated in FIG. 1, the apparatus 100 includes a central processing computer and/or computer system 10 (hereinafter referred to as the “central processing computer 10”). The central processing computer 10 can also be a server computer and/or server computer system. In this manner, the central processing computer or computer system can be any computer or computer system and/or can be a network computer or network computer system and/or a server computer and/or server computer system, depending upon the application.

The apparatus 100, in the preferred embodiment, also includes a plurality of remote user computers or communication devices 30 (hereinafter referred to as “remote user device 30”). Each of the remote user devices 30 is connected and/or linked with the central processing computer 10 via a communication network or medium. In the preferred embodiment, the communication network or medium is a telecommunication and/or telephone communication network. The telecommunication and/or telephone network may be a line-connected communication network and/or a wireless communication network.

The communication network and/or medium which may be utilized in conjunction with the apparatus and method of the present invention may be any suitable communication system and/or network for transmitting information and/or data, including multimedia, video, and/or audio information and/or data or any other suitable information and/or data. In this regard, the communication network and/or medium may be a radio communication network or system, a digital communication network or system, a satellite communication network or system, a personal communications services (PCS) network or system, a telecommunication network or system, an optical communication network or system, a broadband communication network or system, a Bluetooth communication network or system, a streaming video communication network or system, streaming audio communication network or system, a live video communication network or system, and/or any other suitable communications network or system, and/or any combination(s) thereof.

The communications system utilized may operate anywhere in the electromagnetic and/or radio signal frequency spectrum. As noted above, wireless communication networks and associated wireless communications devices, including wireless modems, may be utilized in conjunction with the present invention.

The respective central processing computer 10 and remote user device(s) 30, which may be utilized, in the preferred embodiment, can be equipped with the respective and/or corresponding communication equipment for transmitting and/or receiving the signals, data and/or information associated with the utilized communication network, and/or system, and/or any combination(s) thereof.

In the preferred embodiment, the central processing computer 10 is a typical central and/or server computer such as those utilized in conjunction with an on-line service and/or in network environments as utilized in conjunction with the Internet, the World Wide Web and/or any other suitable network or network environment. In the preferred embodiment, the remote user device 30 is a personal computer (PC) which may be a home or personal computer and/or a laptop computer.

While a personal computer is described as being utilized in the preferred embodiment, it is also envisioned that the remote user device 30 or device may also be any suitable personal communication device, such as, a personal communication device and/or a personal communication services (PCS) device, a personal digital assistant, a video telephone, a cellular telephone, a line-connected telephone, a wireless or cordless telephone, a digital communication device, a digital telephone, a digital television, a high definition television, and/or an interactive television. In this regard, the present invention may be utilized with any suitable device(s) for facilitating communications and/or data and/or information transfer in conjunction with the central processing computer 10 in any suitable communications and/or network environment.

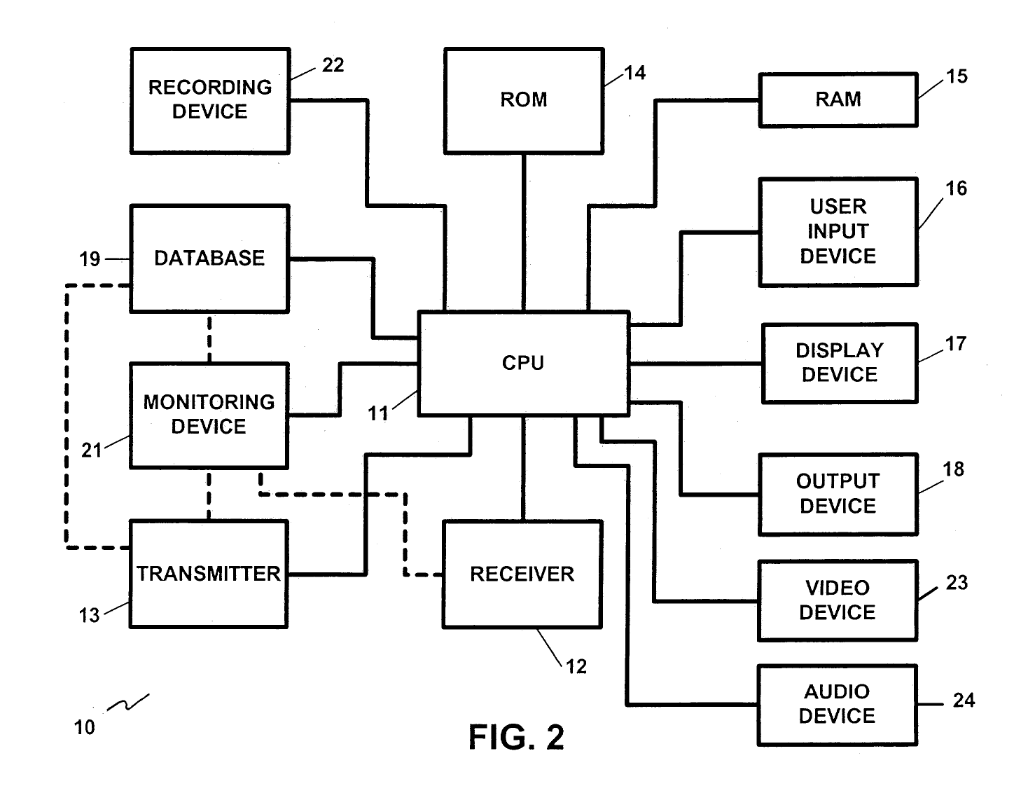

FIG. 2 illustrates a block diagram of the central processing computer 10 which is utilized in the preferred embodiment of the present invention. In FIG. 2, the central processing computer 10 includes a central processing unit (CPU) 11. The central processing unit (CPU) 11 may be a microprocessor, a microcomputer, a minicomputer, a macro-computer, and/or a mainframe computer, depending upon the application. The central processing computer 10 also includes a receiver 12 for receiving signals which are transmitted to the central processing computer 10, and which is connected to the CPU 11. A wireless modem may also be utilized as the receiver 12 for use in conjunction with the central processing computer 10. The central processing computer 10 also includes a transmitter 13 for transmitting signals from the central processing computer 10 to the remote user device(s) 30, which transmitter 13 is also connected to the CPU 11. A wireless modem may also be utilized as the transmitter 13 for use in conjunction with the central processing computer 10.

The central processing computer 10 also includes a read only memory (ROM) 14 and a random access memory (RAM) 15 which are also connected to the CPU 11. The central processing computer 10 also includes a user input device(s) 16 which comprise(s) any one or more of a keyboard, a scanner, a user pointing device, such as, for example, a mouse, an audio input device, a video input device, etc., which input device(s) is also connected to the CPU 11. The server computer also includes a display device 17, such as a display monitor, which is also connected to the CPU 11, and an output device 18, such as a printer, a fax/modem, etc., which output device is also connected to the CPU 11.

The central processing computer 10 also includes a database(s) 19, wherein various information and/or data is stored and which is also connected to, and accessible by, the CPU 11. Various educational and/or instructional material and/or data and/or information is stored in the database 19. The educational and/or instructional material and/or data and/or information, in the preferred embodiment, includes multimedia, video and/or audio taped instruction sessions which provides multimedia audio and/or video material for presentation to a user or student as will be described below. The educational and/or instructional material and/or data and/or information can also include text information, images, graphics, video information, audio information, and/or any combination of same.

The educational and/or instruction material, in the preferred embodiment, can be, or is, video taped instructional classes, lectures, and/or segments, which can be in the form of multimedia presentations which can contain video and audio material and/or which can be video and audio material. The educational and/or instructional material may employ graphics and/or sound so that the user or student may derive optimal benefits from the presentation. In this regard, the student can be placed inside a virtual classroom via his or her remote user device 30.

The data and/or information which is stored in the database(s) 19 may also include course and/or degree and/or certificate program data and/or requirements, continuing education requirements, administrative and/or other management data and/or information, etc. The database(s) 19 may contain student announcements for the remote student. The data and/or information stored in the database(s) 19 may also contain any and all data and/or information, including data and information pertaining to the user(s), student(s), instructor(s), administrators, etc. The database(s) 19 may also include data and/or information pertaining to course and/or program management, including data and/or information for monitoring a user(s) and/or a student(s) progress and/or progression through a course and/or program.

The database(s) 19 may also include, and/or be linked to a other database(s) (not shown), which includes courses and/or text materials, such as textbook(s) and/or coursebook(s) material, outside and/or required and/or supplemental materials and/or data or information, and/or presentations, and/or reserved reading and or instructional materials, such as materials which may usually be placed on reserve in a library by an instructor. The database(s) 19 may be both internal to the central processing computer 10 and/or the database(s) 19 may be external databases, such as for example, a specialized and/or designated on-line service or system database, which may be accessed by the central processing computer 10 and/or by the remote user device 30.

The database 19 can also include educational and/or instructional material, and/or segments thereof, which can be provided by or from different instructional sources, schools, and/or educational institutions.

The central processing computer 10 also includes a monitoring device 21 which is also connected to and controlled by the CPU 11. The monitoring device 21 may also be connected to the transmitter 13 and/or to the database 19. The monitoring device 21 may serve to monitor a user and/or a students accessing of the various data and/or information from the database 19, including the user and/or students viewing of the instructional information presentation and/or segments. The monitoring device 21 may also monitor and/or keep track of the amount of data and/or information which is transmitted to the remote user device 30 for a given user, student and/or other individual.

In the preferred embodiment, the educational and/or instructional materials and/or data and/or information, and in particular, the courses and/or instructional material, may be encoded and/or digitally and/or otherwise encoded or marked, time encoded and/or time marked, and/or have frame reference numbers associated therewith, and/or otherwise may be tracked and/or monitored by devices such as tape counters, etc., so that the monitoring device 21, and therefore, the central processing computer 10, may record and maintain a record of the materials, information and/or data and/or any amount thereof, which is or which has been transmitted to a given remote user device 30 during or for a given period and/or periods. In this manner, the monitoring device 21 given may monitor and record and store the start and stop locations in the presented materials, information and/or data, for a given transmission to a given remote user device 30.

In the preferred embodiment, the monitoring device 21 and/or the central processing computer 10, as will be described herein, will record and store respective stop locations in the educational and/or instructional materials. As will be described herein, the central processing computer 10 will calculate and/or determine a start location, in the educational and/or instructional materials, from which a subsequent session and/or transmission of the educational and/or instructional materials to the student will commence.

The encoding and/or marking of the educational and/or instructional material and/or the data and/or information described herein may be accomplished via any of the conventionally known methods for encoding and/or marking data for facilitating the record keeping functions and/or monitoring functions described herein. The educational and/or instructional materials can be encoded and/or marked, digitally and/or otherwise. The educational and/or instructional materials can also be time marked such that locations in the materials can be correlated with a time and/or a time stamp.

The educational and/or instructional materials can be also be provided with video frame reference numbers for facilitating the monitoring functions described herein. The educational and/or instructional materials can also be utilized in conjunction with, and/or be correlated with, tape counting devices. The educational and/or instructional materials can also be encoded, marked and/or stamped in any other appropriate and/or suitable manner for facilitating the monitoring functionality and/or the monitoring and/or record keeping of the respective stop and start locations in the educational and/or instructional materials which are described herein. Applicant hereby incorporates by reference herein the subject matter of U.S. Pat. No. 5,969,714 which teaches and discloses an interactive video system with frame reference number.

As an alternative to encoding the data and/or information, a counting device, digital and/or otherwise, such as for example, those counting devices utilized in video cassette recorders and/or players, may also be employed. In this regard, any suitable encoding, timing and/or counting methods and associated devices, if necessary, may be utilized so as to monitor the start and stop locations of, and/or in, the educational and/or instructional materials and/or the course presentation, provided that the start and stop locations and, therefore, the user or student's progression through the materials can be ascertained, recorded and stored. The user or student progression through the information and/or materials can be stored at the central processing computer 10 in any appropriate database and/or in the user's or student's remote user device 30.

The encoding and/or marking of the data and/or information described herein may be accomplished via any of the conventionally known methods. As a alternative to encoding the data and/or information, a counting device, digital and/or otherwise, such as for example, those counting devices utilized in video cassette recorders and/or players, may also be employed. In this regard, any suitable encoding, timing and/or counting methods and associated devices, if necessary, may be utilized so as to monitor the start and stop locations of, and/or in, the educational and/or instructional materials and/or the course presentation, provided that the start and stop locations and, therefore, the user or student's progression through the materials can be ascertained, recorded and stored. The user or student progression through the information and/or materials can be stored at the central processing computer 10 in any appropriate database and/or in the user's or student's remote user device 30.

In a situation where a user and/or a student wishes to view a lecture and/or a presentation, the monitoring device 21 will record the start location of the lecture. When the student wishes to end the viewing if the lecture, or portion thereof, the monitoring device 21 will then record the stop location of the lecture. The monitoring device 21 may be utilized to monitor and/or record a user's and/or student's progression and/or viewing for all of the possible information which is accessible to the student from the apparatus 100 for a given course of instruction. In this manner, the student may view and/or progress through a course and/or presentation at his or her own pace, via the remote user device 30.

In any and/or all of the embodiments described herein, the educational and/or instructional materials can include video materials, audio materials, and/or audio and video material (audio-visual materials), text materials, images, graphics, and/or any other form or type of materials.

The student may also access all database materials, i.e. text materials, test materials, research materials, reserved and/or extra reading materials, and progress through same in the manner described above wherein progression may be monitored and/or recorded by and/or at the central processing computer 10. The student's progression information, start and stop data, and/or other progression data, may also be available to the student so that the student can keep track of same so as to mark his or her own progression. This data may be stored in the remote user device 30 and/or be retrieved from the central processing computer 10.

The apparatus 100 is also equipped so as to enable a user or student to re-view lectures, course presentations, and/or other database materials available, via the central processing computer 10. In this regard, the course presentation and/or other materials will be encoded and be available to the user or student at any time. The user or student need only input the codes representing the lectures and/or presentations, or portions thereof, which he or she wishes to view or re-view. The user or student may view or re-view any lectures and/or materials, and/or portions thereof, at any time during the course offering or availability, semester, trimester, etc. In this manner, the user or student may be capable of going back over the lectures and/or other course presentations and/or materials as many times and/or as often as he or she wishes.

The database 19 contains data and/or information for the course lectures, text materials, reserved materials, research materials, test materials, student records, administration and/or institutional records, degree and/or other program requirements and offerings related thereto. All of the above data, information and materials may be in any one or more of a multimedia, audio, video and/or text format and/or be in any other suitable format which is consistent for presentation over an on-line environment and/or medium.

In the preferred embodiment, the lecture and/or course presentation materials, and/or other presentation materials, are and/or can be provided in a multimedia format, where appropriate, so that a multimedia presentation may be available to the user or student. The materials and/or presentations, where appropriate, may also be available in split screen or multiple screen format so that the lecture and/or course presentation may also include a view of the lecturer as well as a visual presentation medium such as a blackboard, illustrative pictures, etc and/or any other course related or program related materials. Such a multiple screen presentation may assist the user or student in understanding the presentation and/or for facilitating ease of note-taking. In this regard, a blackboard containing notes may also be presented in the split screen format.

The apparatus and method of the present invention may also be utilized in conjunction with live broadcasts of classes and/or other educational and/or instructional presentations. In this regard, the central processing computer 10 will receive the broadcast data and or information via the receiver 12. The central processing computer 10 may also have a recording device 22 associated therewith for recording live broadcasts and/or presentations, for storage and for later presentation, in the database 19. Such a recording device may include a compact disk recording device for recording information onto a compact disk, or a video recording device such as for recording information on a video tape. Other appropriate recording devices and/or mediums may also be employed.

Any and all or the taped and/or pre-recorded educational and/or instructional materials and/or presentations, and/or administrative announcements, and/or the reserved and/or supplemental materials and/or any other data and/or information which is provided to, and/or which may be made available and/or accessible to the student, in the preferred embodiment, is marked, digitally and/or by any other appropriate manner, so that the central processing computer 10 and the user or student may record and/or store the user's or student's point of progression through the materials and/or presentations. This progression data may be stored at the central processing computer 10 in a database of student accounts as well as be saved in the remote user device 30 of the user or student. In this manner, a student may progress through the course and/or materials, and/or review materials, at his or her convenience and/or at his or her own pace.

The central processing computer 10 can also include a video recording device 23 and an associated audio recording device 24 which are connected with the CPU 11 and which can facilitate video conferencing and/or audio conferencing between any of the instructors, educators, and/or administrators, and the students described herein. In the preferred embodiment, the video recording device 23 can be a camera, digital, analog, and/or otherwise, which can be utilized in conjunction with use of a personal computer or other personal communication device for facilitating video conferencing, line instruction and/or other communication, and/or for recording video for later transmission and/or playback over the network of the apparatus 100.

In the preferred embodiment, the audio recording device 24 can be any communication device or devices, such as, but not limited to, a telephone headset comprising a microphone transmitter and receiver, a telephone, a microphone with associated speaker for receiving an audio transmission, and/or any other device for facilitating communication between any of the envisioned users of the apparatus 100, digital, analog, and/or otherwise, which can be utilized in conjunction with use of a personal computer or other personal communication device for facilitating video conferencing, line instruction and/or other communication, and/or for recording video for later transmission and/or playback over the network of the apparatus 100.

The apparatus 100 may also monitor the dissemination of the materials to the user or student, such as in instances when a user's or student's review or reception of the materials may be necessary and/or required. The central processing computer 10, as well as the remote user device 30, in the preferred embodiment, are or can be equipped to monitor user or student progression through these materials and, are or can be equipped so as to store data and/or information pertaining to the encodings and/or markings on the taped materials. In this manner, the central processing computer 10 as well as the user or student will have the user's or student's progression data available at all times.

That the educational and/or instructional materials and/or presentations can also be transmitted live, via the apparatus, to the user or student. In this regard, the apparatus 100, in another preferred embodiment, may also comprise an instructional broadcasting device (not shown) which can be utilized in conjunction with the central processing computer 10. The broadcasting device may also be connected to the CPU 11 so that its operation may be controlled and/or monitored.

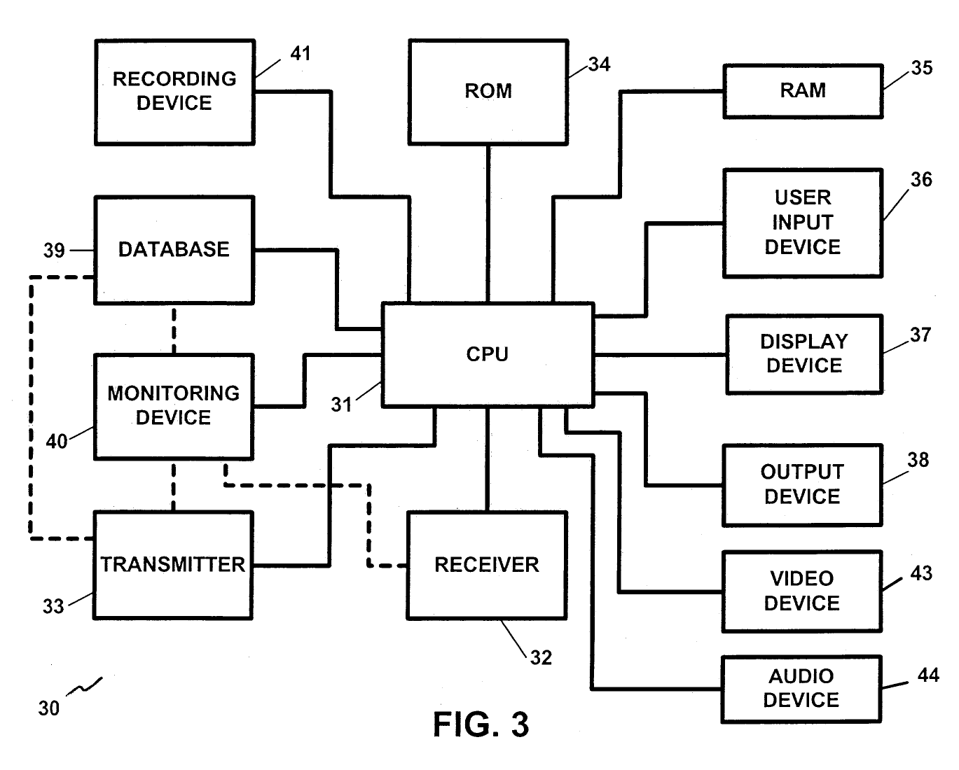

FIG. 3 illustrates a block diagram of the remote user device 30 which is utilized in the preferred embodiment of the present invention. In FIG. 3, the remote user device 30 includes a central processing unit (CPU) 31. The central processing unit (CPU) 31 may be a microprocessor, a microcomputer, a minicomputer, a macro-computer, or a mainframe computer, depending upon the application.

The remote user device 30 also includes a receiver 32 for receiving signals which are transmitted from the central processing computer 10 and/or from any other appropriate device, including, for example, an on-line service, which may be utilized in conjunction with the apparatus 100, and which is connected to the CPU 31, a transmitter 33 for transmitting signals from the remote user device 30 to the central processing computer 10 and/or to any other appropriate device, including, for example, an on-line service, which may be utilized in conjunction with the apparatus 100, and which transmitter 33 is also connected to the CPU 31. A wireless modem may also be utilized as the receiver 32 and/or as the transmitter 33.

The remote user device 30 also includes a read only memory (ROM) 34 and a random access memory (RAM) 35 which are also connected to the CPU 31. The remote user device 30 also includes a user input device(s) 36 which comprise any one or more of a keyboard, a scanner, a user pointing device, such as, for example, a mouse, an audio input device, a video input device, etc., which input device(s) is also connected to the CPU 31. The remote user device 30 also includes a display device 37, such as a display monitor, and an output device 38, such as a printer, a fax/modem, etc., which output device is also connected to the CPU 31. The remote user device 30 also includes a database(s) 39, wherein the various educational and/or instructional materials, information and/or data, which corresponds to the user's or student's studies and/or related data and/or information, may be stored.

The database(s) 39 may also contain course materials and/or information, and/or degree and/or certificate program data and/or requirements, as well as administrative and/or other data and/or information pertinent to the program and/or the user(s) and/or student(s). The database(s) 39 may also contain any and all data and/or information, including data and information pertaining to the user(s), student(s), instructor(s), administrator(s), etc. The database(s) 39 may also contain data and/or information pertaining to course and/or program management, including data and/or information for monitoring a user's and/or a student's progress and/or progression through a course or program. In this regard, the start and stop location data, which keeps track of, and/or monitors, the user or student progression though the materials and/or presentations, may be stored in the database 39.

The database(s) 39 may also contain, and/or be linked to, an external database(s) (not shown) which may include course or text materials, such as the full or partial text of textbooks and/or coursebooks, outside and/or supplemental reading and/or instructional materials, such as materials usually placed on “reserve” in a library by an instructor. The database(s) 39 may be internal to the remote user device 30 and/or may be external to the remote user device 30 and may contain or include database(s) associated with a specialized and/or designated on-line service or system database, which may be accessed by the remote user device 30 and/or by the central processing computer 10. The remote user device 30 also includes, in the preferred embodiment, a monitoring device 40 for monitoring the information and/or materials which are received at, and/or viewed at, the remote user device 30. The monitoring device 40 is connected to the CPU 31 and/or to the receiver 32 and/or to the database 39.

The remote user device 30 also includes a recording device 41 which, in the preferred embodiment, is a multimedia recording device for recording any of the materials and/or information made available to the user or student via the central processing computer 10 and/or via the apparatus 100. The recording device 41 may be a compact disc recording device, a video recorder and/or any other suitable recording device, for recording multimedia and/or other suitable information.

The remote user device 30 can also include a video recording device 43 and an associated audio recording device 44 which are connected with the CPU 31 and which can facilitate video conferencing between any of the students and the instructors, educators, and/or administrators or other students, described herein. In the preferred embodiment, the video device 43 can be a camera, digital, analog, and/or otherwise, which can be utilized in conjunction with use of a personal computer or other personal communication device for facilitating video conferencing, line instruction and/or other communication, and/or for recording video for later transmission and/or playback over the network of the apparatus 100.

In the preferred embodiment, the audio device 44 can be any communication device or devices, such as, but not limited to, a telephone headset comprising a microphone transmitter and receiver, a telephone, a microphone with associated speaker for receiving an audio transmission, and/or any other device for facilitating communication between any of the envisioned users of the apparatus 100, digital, analog, and/or otherwise, which can be utilized in conjunction with use of a personal computer or other personal communication device for facilitating video conferencing, line instruction and/or other communication, and/or for recording video for later transmission and/or playback over the network of the apparatus 100.

The apparatus and method of the present invention can be utilized in conjunction with other apparatuses and methods in the prior art, and further, the present invention can be incorporated with these known apparatuses and methods so as to improve upon them and so as to further define additional applications for the present invention as well as the teachings in the prior art. In this regard, Applicant hereby incorporates by reference herein the subject matter and teachings of the following U.S. Patents: U.S. Pat. No. 5,727,950 which teaches an agent based instruction system and method; U.S. Pat. No. 5,458,494 which teaches a remotely operable teaching system and method therefor; U.S. Pat. No. 5,788,508 to Lee which teaches an interactive computer aided natural learning method and apparatus; U.S. Pat. No. 5,002,491 which teaches an electronic classroom system enabling interactive self-paced learning; U.S. Pat. No. 5,537,141 which teaches a distance learning system providing individual television participation, audio responses and memory for every student; U.S. Pat. No. 4,768,087 which teaches an education utility; U.S. Pat. No. 5,310,349 which teaches an instructional management system; U.S. Pat. No. 5,318,450 which teaches a multimedia distribution system for instructional materials; U.S. Pat. No. 5,769,643 which teaches an instruction communication system; U.S. Pat. No. 5,528,281, which teaches a method and system for accessing multimedia data over public switched telephone network; U.S. Pat. No. 5,157,491 which teaches a method and apparatus for video broadcasting and teleconferencing; U.S. Pat. No. 5,410,343 which teaches video-on-demand services using public switched telephone network; U.S. Pat. No. 5,303,042 which discloses computer-implemented method and apparatus for remote educational instruction; U.S. Pat. No. 5,347,306 which discloses animated electronic meeting place; U.S. Pat. No. 5,509,009 which discloses a video and aural communications system; U.S. Pat. No. 5,510,832 which discloses a synthesized stereoscopic imaging system and method; U.S. Pat. No. 5,381,412 which discloses a multimedia communications apparatus; U.S. Pat. No. 5,508,733 which discloses a method and apparatus for selectively receiving and storing a plurality of video signals; U.S. Pat. No. 4,645,872 which discloses a videophone network system; U.S. Pat. No. 5,192,999 which discloses a multipurpose computerized television; U.S. Pat. No. 5,969,714 which discloses an interactive video system with frame reference number, U.S. Pat. No. 5,772,446 which discloses an interactive learning system, U.S. Pat. No. 5,978,648 which discloses an interactive multimedia performance assessment system and process for use by students, educators and administrators, and U.S. Pat. No. 4,882,743 which discloses a multi-location video conference system.

Applicant also hereby incorporates by reference herein the teachings of “World Wide Web—Course Tool: An Environment for Building WWW-Based Courses”, Murray W. Goldberg. Fifth International World Wide Web Conference, May 1996; “Virtual MBA”, McCartney, Laton, Informationweek, November 1996; and “Internet, Education, and the Web,” Houstis, et al. Proceedings of WET ICE, 1996.

The communication equipment, including the various and/or respective receivers and/or transmitters and/or transceivers, if utilized, may be selected from any one of the well known and/or suitable communication devices which may be utilized with any one or more of the above-noted communication networks and/or systems. Further, the communication equipment, including the receivers, transmitters, and/or transceivers, may be utilized anywhere in the electromagnetic and/or radio signal frequency spectrum and/or in conjunction with any other suitable communication medium and/or environment.

Data and/or information is freely exchangeable and/or transferable between the central processing computer 10 and the remote user device 30. In this regard, all educational and/or instructional materials and/or presentations, textbook and/or coursebook and/or course materials, “reserve” and/or other supplemental course materials, institutional and/or administrative announcements, tests and/or examinations, etc., may be transferred from and/or between the central processing computer 10 to the remote user device 30. Completed assignments, completed tests and/or examinations, questions and/or inquiries to an instructor, etc., may also be transferred from and/or between the remote user device 30 to the central processing computer 10. In this regard, the apparatus 100 of the present invention provides an apparatus and system for enabling a user or student to attend, and/or participate in, an educational environment, as if he or she were attending classes or courses at an educational institution.

The central processing computer 10, in the preferred embodiment, monitors the user's or student's viewing of and/or progressions through the course materials, so as to monitor and/or record the user's and/or student's progress, i.e. what the user and/or student has viewed, so as to monitor and/or record user and/or student progression through the course and/or instructional materials. In this manner, if a user or student can only view a portion or segment of a lecture or presentation, the user or student may view the lecture or presentation in portions, with the central processing computer 10 and/or the remote user device 30 monitoring, recording and/or keeping track of the user's and/or student's progression and/or place.

In this regard, the apparatus 100 provides for an electronic place marker for the user or student. The central processing computer 10, in the preferred embodiment, is also capable of allowing the user and/or student to re-view and/or replay any portions of any classes, courses and/or instructional materials. In this regard, the user and/or student may replay and/or review any classes and/or lectures so as to further clarify and/or so as to reinforce his understanding of the course subject matter.

The central processing computer 10 may transmit text materials, supplementary materials, notes, institutional and/or administrative announcements, research materials and/or test and/or tests materials, to the remote user device 30, which materials may be down-loaded by the user and/or student at the remote user device 30 and/or stored on an appropriate storage device, such as a hard disk, a diskette, a floppy disk and/or a compact disk and/or any other appropriate storage device and/or medium. The material may be viewed on the display monitor and/or may printed out via a printer or other suitable device.

The present invention provides an apparatus and a method for providing educational and/or instructional information and materials to a remote user or student in a network environment. The apparatus and method of the present invention also facilitates professional and/or other continuing education programs and offerings.

In this manner, the apparatus and method of the present invention facilitates on-line and/or network dissemination of educational and/or instructional materials and/or information so as to allow an individual to attend or participate in classes and/or in courses of instruction, from a remote location on, or over, a network environment, such as on, or over, the Internet, The World Wide Web, and/or any other suitable communication network.

The operation and/or manner of use of the apparatus 100 and method of the present invention is described hereinbelow in connection with its use in providing educational and/or informational services to individuals and/or groups thereof, in a network environment and at a location remote from the offering institution. In this manner, the individual(s) may attend classes and/or courses so as to matriculate in degree programs, certificate programs, continuing education programs and/or other type of study, at any participating educational institution, regardless of its geographic location vis-a-vis the individual(s).

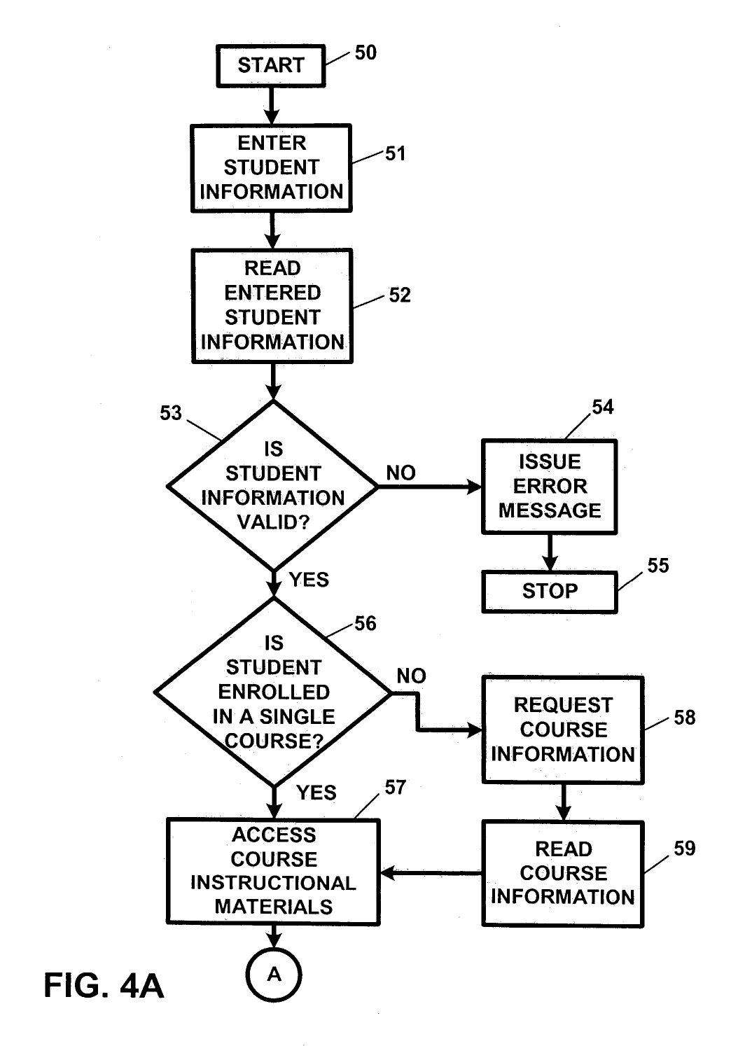

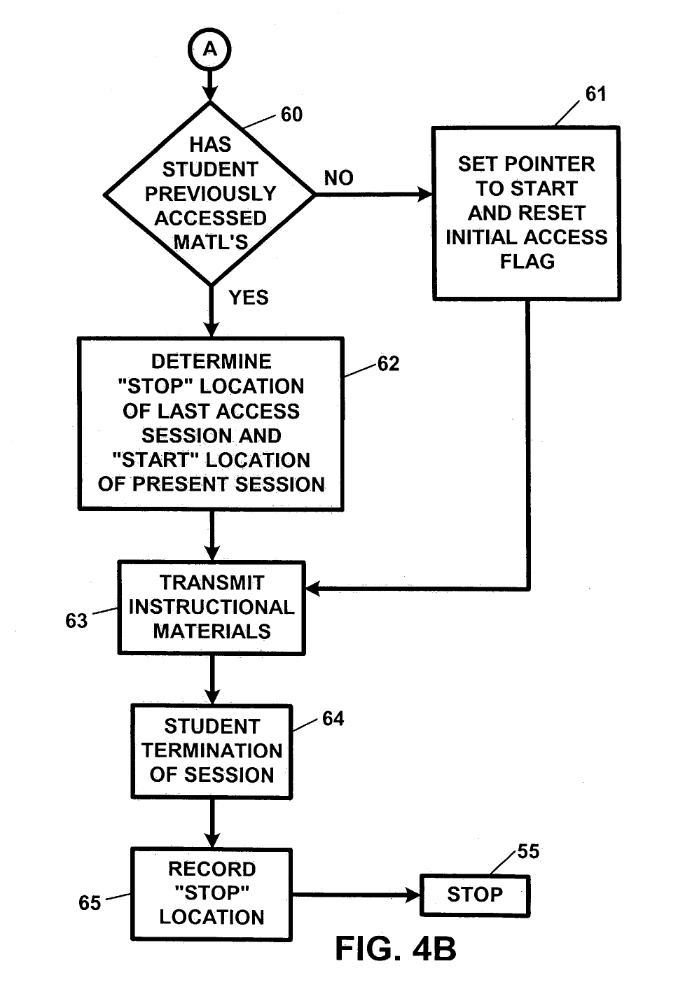

A preferred embodiment operation of the present invention is described as follows with reference to the flow diagram illustrated in FIGS. 4A and 4B. In the embodiment of FIGS. 4A and 4B, the apparatus 100 and method of the present invention provides a self-paced distance learning system and/or environment wherein a user or student may access the central processing computer 10 and access and/or receive the transmission of educational and/or instructional material. In the embodiment of FIGS. 4A and 4B, the central processing computer 10 will record and store a stop location in the educational and/or instructional materials, defined as a “first location” or “first position”, and which is the location in the educational and/or instructional materials where the user or student terminates a transmission and/or a receipt of same. In a subsequent session, the transmission of the educational and/or instructional materials will resume from a start location in the educational and/or instructional materials, defined as a “second location” or “second position”.

The terms “stop point”, “stop location” and/or “stop position” can be used interchangeably herein. In the same manner, the terms “start point”, “start location”, and/or “stop position” can also be used interchangeably herein. The terms “first location” or “first position” are defined to refer to the “stop point”, “stop location”, or “stop position”. The terms “second location” or “second position” are defined to refer to the “start point’, “start location”, or “start position”.

The start location will be determined and/or be calculated so as to be a location in the educational and/or instructional materials which is prior to the stop location, in the educational and/or instructional materials, so as to provide a certain amount of review for the student, of the educational and/or instructional materials previously received by the user or student, prior to reaching and continuing from the previously stored stop location. In this manner, the user or student can receive a certain amount of review and/or overlap, of the educational and/or instructional materials, so as to provide continuity in the user's or student's receiving of the educational and/or instructional materials, so as to provide a review or refresher for the user or student prior to the user's or student's receiving new educational and/or instructional material, and/or so as to prevent the user or student from missing any of the educational and/or instructional materials at or near the point of a termination of a previous session as well as at or near a point of a commencement of a subsequent session.

In the above-described manner, the present invention provides the user or student with a certain amount of a review or replay of previously presented educational and/or instructional materials prior to providing the user or student with new material. The review or replay of the educational material can also be referred to as “educational material review” or any other equivalent term, phrase, or terminology. The amount of review or refresher material can also be referred to as “an amount of educational material review” or any other equivalent term, phrase, or terminology. The start location or start position can be selected and/or chosen to by anywhere in between the beginning point of the materials and the stop location or stop position of the previous session.

In any of the embodiments described herein, the amount of review or replay material can be automatically determined, and the start location or start position can be determined or computed, automatically by the central processing computer 10 which can be programmed by any one or more of the user, student, administrator, educator, and/or educational institution for performing this functionality. The amount of review or replay can also be selected and/or dictated by the user or student at the time of the current session, the previous session, and/or at any other time, and/or can be selected and/or dictated by the user or student in real-time. If a user or student may have felt that his or her attention span was less than optimal, he or she may request or select a longer review or reply period or amount of materials.

The user or student may select or pre-select, and/or change, and/or dictate, the amount of the review and/or overlap in the educational and/or instructional materials, at any time, including, but not limited to the time of each accessing of the materials, at the time of the student's registration in the respective course or program, at the time of a termination of a session, and/or at any other time. The administrator of the central processing computer 10 and/or the educational institution offering the course or program can also select or dictate the amount of review and/or overlap.

In the embodiment of FIGS. 4A and 4B, the stop location can be defined to be the point, in the educational and/or instructional materials, where the transmission of the materials actually stops, the point, in the educational and/or instructional materials, where the transmission of the materials actually stops from the central processing computer, the point, in the educational and/or instructional materials, where the user or student turns off his or her remote user device 30, and/or otherwise stops receiving the materials, and/or the point, in the educational and/or instructional materials, where the user or student requests that the transmission of the materials be terminated.

The amount of review of overlap can be determined for, and/or can be dependent upon, and/or be selected for, the manner in which the stop location is defined and/or selected.

In the embodiment of FIGS. 4A and 4B, the central processing computer 10 can transmit stop location and start location information to the remote user device 30 which information can be displayed on the display of the remote user device 30. The stop and/or start location information can be requested by the user or student and/or the stop and/or start location information can be automatically transmitted to the user or student and/or can be displayed and/or made available to the user or student at any time and/or during the user's or student's viewing and/or receipt of the educational and/or instructional materials.

In FIGS. 4A and 4B, the operation of the apparatus 100 commences at step 50 upon the accessing of the central processing computer 10 by the user or student. The user or student will access the central processing computer 10 via the remote user device 30. The user or student can interface with the central processing computer 10 via the remote user device 30.

Upon accessing the central processing computer 10, the central processing computer 10 will request, at step 51, that the user or student enter student identification information. The central processing computer 10, at step 52, will read the entered student information data. The central processing computer 10 will then, at step 53, determine whether the user or student is a valid user or student of the educational institution. If the user or student is not a valid student, the central processing computer 10 will at step 54, issue a message to the user or student that he or she is not a valid student. The central processing computer 10 will then cease operation at step 55.

If, at step 53, it is determined that the user or student information is valid, the central processing computer 10 will proceed to step 56 and determine whether the user or student is enrolled in a single course with the educational institution. If, at step 56, the central processing computer 10 determines that the user or student is enrolled in a single course the operation of the apparatus will proceed to step 57.

If, at step 56, it is determined that the user or student is enrolled in multiple courses, the central processing computer 10 will proceed to step 58 and query the user or student as to which course the user or student wishes to access. At step 58, the user or student will enter the data corresponding to the course which the user or student wishes to access. The central processing computer 10 will then read the course information at step 59. The operation of the apparatus 100 will then proceed to step 57.

At step 57, the central processing computer 10 will access the education and/or instructional material(s). Prior to the first accessing of the material by the user or student, a predetermined data flag, defined as the initial access flag, will be initially set to a pre-defined value which, in the preferred embodiment, is a “1”. In this regard, each time a user or student registers for a course, the initial access flag for that course will be set to “1”. Upon the first accessing of the education and/or instructional material for that course, the central processing computer 10 will, at step 60, determine if the user or student has previously accessed the course material(s). To perform this function, the central processing computer 10 will determine if the initial access flag is set to “1”. If the user or student has not previously accessed the course material(s), the central processing computer 10 will, at step 61, set the material pointer to the start of the material and reset the initial access flag (i.e. reset the flag to “O”). The starting point, location, or position, of the current session will then be chosen to be and/or defined to be, the start location or start position of the material and/or the location or position in the material from which the material will be transmitted to the user or student. The central processing computer 10 will then proceed to step 63 and the educational and/or instructional materials will be transmitted from the central processing computer 10 to the remote user device 30.

If, at step 60, it is determined that the user or student has previously accessed the materials, then the central processing computer 10 will, at step 62, determine and/or retrieve the stop location, or stop position, in the materials, where the user's or student's last session was terminated or otherwise stopped. This stop location or stop position, in the materials, can also be defined to be the point, location, or position, in the materials where the user or student last viewed and/or accessed the materials and/or the last point, or other defined point in the materials where the student has been deemed to have ended or terminated a previous session.

The central processing computer can, at step 62, determine, compute and/or retrieve, the start location or start position in the materials from which the current session or present session may commence. As noted above, the educational and/or instructional materials can be encoded and/or marked, digitally and/or otherwise, can be time marked or time-stamped, can be numbered with video frame reference numbers, and/or can be divided into track segments, and/or can be encoded, marked and/or numbered in a similar manner and/or in an analogous manner as pre-recorded information is marked and/or presented over a computer system and/or stored on compact disks and/or other storage media, so that the respective stop locations or stop positions and/or start locations or start positions can be identified, stored, computed, and/or otherwise processed and/or utilized in the manner described herein and so as to facilitate the monitoring functionality described herein.

In this regard, Applicant incorporates by reference herein the teachings of the technologies known in the art in image processing and multimedia, along with digital and time encoding of stored data and/or information, which provides for the means by which to utilize encoding and/or marking to encode or mark reference points, locations and/or positions, in the materials which may be utilized in monitoring the dissemination of the educational and/or instructional materials and/or the multimedia and/or other data and/or information described herein. Applicant also incorporates by reference herein the teachings of U.S. Pat. No. 5,969,714 which discloses an interactive video system with frame reference number.

At step 62, the stop location or stop position of the previous session can be utilized to compute or determine the start location or start position of the current session. A start location or start position of a subsequent session can also be determined and/or can be computed from the stop location or stop position. As noted above, the start location or start position can include a certain or pre-specified amount of review or refresher material and/or previously viewed material so as to provide a review or refresher for the student.

The amount of review or refresher material can be selected by the student, the administrator and/or the educational institution, and/or can include any amount of review or refresher material. In another preferred embodiment, the review or refresher material can be defined to be no material thereby resulting in no review or refresher material being presented to the user or student and the start location or start position of the current session, and/or subsequent sessions, being defined to be the stop location or stop position of the previous session.

As noted above, the start point, start location, or start position, can also be defined to be a point or location in the instructional material (i.e., point, location, position, track, segment, time location, etc. as described herein and/or otherwise) which is located at a point or location, in the educational and/or instructional materials, between the beginning of the materials and before, or prior to, the stop point, stop location, or stop position, or marker, at which a prior session had been terminated. In this manner, the student can be provided with at least some of the previously viewed or listened to educational and/or instructional materials so as to provide for at least some overlap or continuity, and/or so as to serve as a review or refresher, prior to resuming viewing or listening from the location in the instructional material where a previous session was terminated.

In a preferred embodiment, the educational and/or instructional materials can be encoded with a digital code, and/or otherwise, with said code being correlated with, and/or embedded in, the educational and/or instructional materials, so as to be identified with the educational and/or instructional materials, and/or with the various portions, segments, and/or frames or other parts thereof.

In an embodiment where the educational and/or instructional materials are encoded by location or position, such as, for illustrative purposes, with codes or markings respectively, from, for example, 1 at the start of the material to 150 at the end of the material, the following scenario may occur. A student may view the materials up to marking 75 and then terminate the session. The stop location or stop position can be recorded and stored to be marking 75.

The central processing computer 10 can determine and/or compute and store the start location or start position from which the next session can begin. This start location or start position can be defined to be 5 markings before the stop location or stop position of the previous session so as to provide 5 markings worth of a review or refresher for the user or student. In this case, the start location or start position will be determined and/or be computed to be 70 and can be stored at the central processing computer 10 and/or at the remote user device 30 of, and/or associated with, the user or student. When the user or student seeks to resume receiving the materials at a current session, the central processing computer 10 will identify marking 75 as the stop location or stop position of the previous session and marking 70 as the start location or start position of the current session.

The start location or start position, and/or the amount of review and/or refresher material, as noted herein, can be pre-selected and/or can be predefined by the central processing computer 10, by an administrator, by an instructor, by the educational institution, and/or by the user or student, and/or otherwise, and can be changed and/or altered at any time and/or in real-time, by any one or more of the above parties. Thereafter, the educational and/or instructional materials will be transmitted to the user or student from marking 70, thereby providing the student with at least some review or refresher material prior to receiving the last viewed material at marking 75 and the new material at marking 76 and beyond.

In an embodiment where the educational and/or instructional materials are encoded by time and/or by time stamping, such as, for illustrative purposes, with codes or markings respectively, representing units of time from, for example, 0 hours, 0 minutes and 0 seconds, at the start of the material to 40 hours, 30 minutes and 15 seconds, at the end of the material, the following scenario may occur. A student may view the materials up to time marking 4 hours, 27 minutes, 35 seconds, and then terminate the session. The stop location or stop position can be recorded and stored to be time marking 4 hours, 27 minutes, 35 seconds.

The central processing computer 10 can determine and/or compute and store the start location or start position from which the next session can begin. This start location or start position can be defined to be 10 minutes before the stop location or stop position of the previous session so as to provide 10 minutes of a review or refresher for the user or student. In this case, the start location or start position will be determined and/or be computed to be 4 hours, 17 minutes, 35 seconds, and can be stored at the central processing computer 10 and/or at the remote user device 30 of, and/or associated with, the user or student. When the user or student seeks to resume receiving the materials at a current session, the central processing computer 10 will identify time marking 4 hours, 27 minutes, 35 seconds as the as the stop location or stop position of the previous session and time marking 4 hours, 17 minutes, 35 seconds, as the start location or start position of the current session.

The start location or start position and/or the amount of review and/or refresher material, as noted herein, can be pre-selected and/or can be predefined by the central processing computer 10, by an administrator, by an instructor, by the educational institution, and/or by the user or student, and/or otherwise, and can be changed and/or altered at any time and/or in real-time, by any one or more of the above parties. Thereafter, the educational and/or instructional materials will be transmitted to the user or student from time marking 4 hours, 17 minutes, 35 seconds, thereby providing the student with at least some review material or refresher material prior to receiving the last viewed material at time marking 4 hours, 27 minutes, 35 seconds, and the new material at time marking 4 hours, 27 minutes, 36 seconds and beyond.

In an embodiment where the educational and/or instructional materials are encoded and/or embedded with frame reference numbers, video frame reference numbers, audio frame reference numbers, and/or any other frame reference numbers, codes or markings respectively, from, for example, frame number 1 at the start of the material to frame number 45,763, at the end of the materials, the following scenario may occur. A student may view the materials up to frame number 2,567 and then terminate the session. The stop location or stop position can be recorded and stored to be frame number 2,567.

The central processing computer 10 can determine and/or compute and store the start location or start position from which the next session can begin. This start location or start position can be defined to be 400 frames before the stop location or stop position of the previous session so as to provide 400 frames of a review or refresher for the user or student. In this case, the start location or start position will be determined and/or be computed to be frame number 2,167 and can be stored at the central processing computer 10 and/or at the remote user device 30 of, and/or associated with, the user or student. When the user or student seeks to resume receiving the materials at a current session, the central processing computer 10 will identify frame number 2,567 as the stop location or stop position of the previous session and frame number 2,167 as the start location or start position of the current session.

The start location or start position, and/or the amount of review and/or refresher material, as noted herein, can be pre-selected and/or can be predefined by the central processing computer 10, by an administrator, by an instructor, by the educational institution, and/or by the user or student, and/or otherwise, and can be changed and/or altered at any time and/or in real-time, by any one or more of the above parties. Thereafter, the educational and/or instructional materials will be transmitted to the user or student from frame number 2,167, thereby providing the student with at least some review or refresher material prior to receiving the last viewed material at frame number 2,567 and the new material at frame number 2,568 and beyond.

In another embodiment, the apparatus 100 can be utilized in conjunction with a tape counter such as those found in video recorders and in video cassette recorder (VCRs). In an embodiment where the educational and/or instructional materials are utilized in conjunction with a tape counter, the materials have to be calibrated so that the beginning of the materials corresponds to a count, such as for example count number 0. A user or student may view the materials up to count number 589 and then terminate the session. The stop location or stop position can be recorded and stored to be count number 589.

The central processing computer 10 can determine and/or compute and store the start location or start position from which the next session can begin. This start location or start position can be defined to be 50 counts before the stop location or stop position of the previous session so as to provide 50 counts of a review or refresher for the user or student. In this case, the start location or start position will be determined and/or be computed to be count 539 and can be stored at the central processing computer 10 and/or at the remote user device 30 of, and/or associated with, the user or student. When the user or student seeks to resume receiving the materials at a current session, the central processing computer 10 will identify count number 589 as the stop location or stop position of the previous session and count number 539 as the start location or start position of the current session.

The start location or start position, and/or the amount of review and/or refresher material, as noted herein, can be pre-selected and/or can be predefined by the central processing computer 10, by an administrator, by an instructor, by the educational institution, and/or by the user or student, and/or otherwise, and can be changed and/or altered at any time and/or in real-time, by any one or more of the above parties. Thereafter, the educational and/or instructional materials will be transmitted to the user or student from count number 539 thereby providing the student with at least some review or refresher material prior to receiving the last viewed material at count number 589 and the new material at count number 539 and beyond.

The student may also select the amount of any of the above-described review, overlap, and/or review or refresher material, and/or review or refresher time, at the time of enrollment or registration and/or at the time of the present session. The amount of any of the above-described review, overlap, and/or review or refresher material, and/or review or refresher time, can be programmed into the server computer 10 by the user or student at any time, and/or in real-time.

The central processing computer 10, at step 63, will then transmit the education and/or instructional material from the central processing computer 10, over the communication medium, to the remote user device 30. Thereupon, the user or student may view the materials on the remote user device 30 which, in the preferred embodiment, is a personal and/or a home computer, laptop computer, a personal communication device, a hand-held device, a telephone, an interactive television, a palm-top device, a personal digital assistant, and/or any other communication device. In the preferred embodiment, the user or student may access the central processing computer 10 and be serviced via a Web Site or Web Page for the institution.

The Web Page may also be provided with, and therefore, provide, additional support features to aid or enhance user or student interaction and/or utilization of the information and/or materials provided by the present invention, with such other features including providing administrative information and or support software which may be in the form of JAVA programs and/or similar Internet programming languages, such as Java applets and/or Java applications. The support software may also be in the form of JAVA program language applications, HTML, C++ and other suitable programs, and may include conventional and/or object-oriented languages and/or programming techniques.

The user or student may then view the educational and/or instructional materials, at step 62, until the class or course segment has been completely viewed and/or until such time as the user or student wishes to terminate the instructional session. As will be noted below, the session may also be interrupted so as to allow the user or student to take a break, ask a question, confer with others, and/or perform ancillary research, etc. Upon such time that the user or student desires to terminate the session, the user or student will, at step 64, terminate the session via the remote user device 30 which will also cause the central processing computer 10 to terminate the session.

Upon session termination, the central processing computer 10 will, at step 65, record and/or store the stop position or stop location (defined herein as the first location or first position) of the educational and/or instructional material. The stop position or stop location will be stored in the central processing computer 10, and/or in the remote user device 30. The stop location or stop position is also stored in conjunction with the student's file in the database 19. At step 65, the central processing computer 10 can also compute and store the start location or start position in the educational and/or instructional materials (defined as the second location or second position) for the next and/or a subsequent session. Upon the storing of the stop location or stop position data, and/or the start location or start position data for the next session and/or a subsequent session, if so computed or determined, at step 65, the central processing computer 10 will terminate the instructional session at step 55.

The start location or start position of the current session and/or of a subsequent session can be determined and/or can be computed, and can be stored at either or both of the central processing computer 10 or the user's or student's remote user device 30, at step 62 and/or at step 65. At step 62, the start location or start position can be computed and/or can be stored during the current accessing session. At step 65, the start location or start position can be determined and/or can be computed and stored at the end of an accessing session and prior to the cessation of the apparatus operation at step 55. In this manner, the start locations or start positions can either be determined and/or computed during a current session and/or the start location or start position can be determined and/or computed and stored during or upon the termination of a previous session.

In addition to encoding, digitally-encoding, marking, time marking and/or time-stamping, and/or providing reference numbering for, the educational and/or instructional materials and/or information, and/or any other materials and/or information related to and/or disseminated via the present invention, the information and/or materials may be stored, at the central processing computer 10 in tracks, or portions, each having defined beginning and ending parameters in a manner such as is similar to the manner in which a music and/or other multimedia information can be stored in segments and/or in portions, such as, for example, on diskettes, floppy disks, audio and video tapes and/or compact disks. For example, course segments and or lectures and/or instructional segments can be divided into track segments, in the same or a similar manner as the manner in which, for example, songs and/or musical or multimedia presentations can be stored on a compact disk. The track portions which may be viewed by the user or student can be recorded at either the central processing computer 10 and/or at the remote user device 30, for each instructional and/or informational segment.

In another preferred embodiment, the central processing computer 10 can have courses stored in the database 19. The courses can be encoded, marked, time-marked, time-stamped, frame numbered, and/or otherwise encoded and/or marked in any of the manners described herein and/or any other suitable manner and/or fashion, so as to present to the user or student with a table of contents or syllabus for allowing the user or student to access and obtain any course materials, or portions thereof, at any time.

The user or student may, in this manner, access and/or obtain any information from any of the courses, or portions thereof, in any order he or she desires. The central processing computer 10 can monitor and record the user's or student's usage of and/or accessing of any of the course materials and/or portions thereof obtained via this preferred embodiment in the same manner as described herein with regards to the embodiment described with reference to FIGS. 4A and 4B and/or any other embodiments described herein.

In another preferred embodiment, the apparatus and method of the present invention can be utilized to provide monitoring of a student's progression through the educational and/or instructional materials by a third party such as, but not limited to, an instructor, an administrator, an employer, a supervisor, and/or any other third party who or which may have an interest in monitoring the student's progression through the educational materials and/or instructional materials, and/or any portion and/or segment of a course or program. The individual, instructor, administrator, employer, supervisor, and/or other third party, desiring to monitor the progression of a student and/or students, can program such a request into the central processing computer 10 by identifying the student, the course and the progression and/or milestone (i.e. when the student has progressed through one half of the course, when the student has taken a certain test, when the student has submitted a certain project, term paper or other assignment, etc.).

The respective individual, instructor, administrator, employer, supervisor, a parent, and/or other third party, can also provide the server computer with contact information in order to facilitate notification via e-mail, telephone message, beeper or pager message, mail generation and/or delivery, and/or via any other appropriate means. Thereafter, the central processing computer 10, upon the conclusion of a transmission of educational and/or instructional materials, and/or upon the conclusion of a course session, and/or upon the submission of an assignment, the taking of a quiz or test, and/or a course completion and/or a course dropping, the central processing computer 10, after updating the student's file and/or records, will query the database 19 in order to determine if conditions exist regarding the student or students which would give rise to providing the requested notification to the respective individual, instructor, administrator, employer, supervisor, a parent, and/or other third party. In this manner, any of the above-identified individuals and/or third parties can be notified regarding, and can monitor, the progress of a student and/or group of students. For example, a student's progress though a course, a taking of a test, a submission of an assignment, and/or any other event and/or progression, can be monitored by a respective individual, instructor, administrator, employer, supervisor, a parent, and/or other third party.

In another preferred embodiment, course and/or instructional information and/or any other information related to the course and/or instructional program may be stored, at the central processing computer 10 in tracks similar to the manner in which a music and/or other multimedia information may be stored in segments and/or in portions. For example, course segments and or lectures and/or instructional segments can be divided into track segments, in the same manner in which songs may be stored on a music compact disk or other storage medium and/or in the manner in which multimedia information may be stored and coded, such as in a multimedia compact disk or other storage medium.

The user or student may also be appraised as to which track segments he or she has viewed. The student or user may, at any time, review and/or replay any track segments and/or tracks so as to review the course and/or instructional presentation and/or materials. In this regard, the present invention provides a means by which the user or student can keep track of what has been viewed and/or may select materials which may be reviewed and/or replayed.

The central processing computer 10 may also be utilized for user or student research purposes and/or for providing the user or student with the opportunity to obtain information related to the course or courses from any and all of the file databases which can be associated and/or which correspond to the course. In this manner, if the instructor referred to reserved and/or supplementary materials and/or to text materials, the user or student may access these databases and view these materials. The user or student may also perform research and/or search through pre-defined, or other, databases. The user or student may download, any of the above materials and/or materials obtained through the above searches via his or her remote user device 30.

In this regard, the present invention provides an apparatus and a method for providing educational and/or instructional materials to the user or student at a remote location. Further, the user or student may progress through the information and/or course materials at his or her own pace. The present invention also provides the user or student with the ability to obtain textbook and/or coursebook materials, reserved and/or supplementary reading and/or other materials, and/or to allow the user or student to perform course-related research and/or searching so as to obtain needed and/or desired information and/or materials for use in conjunction with the coursework.

The user or student, may, at any time, prompt and/or initiate a research session by making an appropriate request via the remote user device 30. The central processing computer 10 may also query the user or student, at various time, as to whether the user or student wishes to perform research and/or to obtain any of the above-described materials from any of the materials and/or information stored in the various databases. The user or student may then simply reply and/or enter his or her research request.

In another preferred embodiment, the central processing computer 10 may, prior to step 55, query the user or student as to whether the user or student desires to obtain any of the above-described information and/or materials. If the user or student wishes to obtain any of the abovedescribed materials, the central processing computer 10 will allow the user or student to obtain same. If the central processing computer 10 determines that the student does not wish to obtain any of the above-described materials, then the central processing computer 10 will prompt the student to exit the system.

At any time during the dissemination of the instructional information and/or materials, the user or student may interrupt and/or pause the transmission of the instructional information and/or materials, such as when the user or student may want to download and/or print-out a screen depicting notes and/or other information and/or to perform research and/or to refer to supplemental and/or other material.

The user or student may also pause the operation of the apparatus so as to take notes and/or to take periodic breaks. In any of the above instances, the pausing will not affect the dissemination of the instructional materials. Further, at any time during apparatus operation, the user or student may download and/or print-out materials available via the apparatus 100. The user or student may, if desired, can also be linked, via the apparatus 100, to various on-line databases, at any time during apparatus operation, so as to allow the user or student to, for example, search an on-line database, such as for example LEXIS/NEXIS, WESTLAW, and/or utilize any one or more of the multitude of various Internet and/or other network search engines and/or to search any of the Internet and/or other network databases. The user or student may download and/or print-out any desired information obtained from and/or during these searches and/or research efforts.

The present invention provides an apparatus and method by which the user or student may review instructional information and/or materials and/or other materials, such as when the user or student wishes to clarify his or her notes and/or to review certain areas of the course materials or related materials. This can be facilitated by providing the user or student with the time and/or digital codes, or track information which represents the start and/or stop locations for the various topics presented during the course and/or which relate to storage locations for the related and/or supplemental materials. The user or student then need only enter the data and/or codes corresponding to the start location of the materials which he or she wishes to review and/or play.

The present invention provides an apparatus and a method by which a user or student may progress through coursework at his or her own pace and from a remote location. The student may also review the instructional segments as many times as is desired and may also obtain all necessary materials, course materials, reserved reading and/or supplemental materials, via the apparatus 100.

In the above manner, a user or student may engage in studies at an educational institution or plurality of institutions regardless of where these institutions are located and regardless of whether the user or student may be located. The user or student may take his or her remote user device 30 on-the-road and without interrupting his or her studies.

In another preferred embodiment, the present invention can be utilized to provide continuing education updates and/or developments, for any given field of knowledge and/or field of study, on a periodic basis. The updates and/or information, in the preferred embodiment, however, may be transmitted to and/or stored in a database associated with, and/or which constitutes part of, the database 19 of the central processing computer 10. The individual can be notified of the presence, and/or occurrence, of the updates upon signing on and/or logging onto the apparatus 100 and, thereafter, receive the updates and/or information via the remote user device 30.

In yet another embodiment, an individual subscribing to a continuing education course, may have electronic message transmissions transmitted to, and stored in, the remote user's device 30 or other e-mail account.

In the above described manner, the present invention can be utilized so as to provide continuing education in the fields of medicine, psychology, law, engineering and technology, social sciences, liberal arts, literature, business and/or in any other field of knowledge. For example, an attorney specializing in given areas of law may receive updates and/or information regarding the latest developments in his or her area of practice. A physician may receive updates in various medical areas. In this manner, an individual may selectively choose those areas and/or fields for which he or she wants to be kept appraised of and receive updates as they become news and/or as they may be made available for dissemination.

The present invention also provides the means by which the user or student may take a test on-line, download the test, and/or retransmit a completed test, on-line, to the central processing computer 10 and/or to a designated location so as to enable the administration of the complete course requirements in conjunction with the apparatus 100. The completed tests and/or any written assignments, papers, homework assignments, etc. may be transmitted by the user or student, such as via a fax and/or an e-mail, etc., to the central processing computer 10 and/or any other designated location and/or to the instructor or administrator of the course or program.

The present invention may also be utilized in a non-network environment wherein educational and/or instructional materials may be encoded on a recording medium, such as a compact disc, a floppy disk, a magnetic tape and/or any other suitable recording and/or storage medium which may be utilized with the remote user device 30.

In any of the herein-described embodiments, the encoded information may also be displayed to the user or student such as, for example, on the display device 37 so as to keep the user of student informed as to the their location and/or point in the instructional materials and/or information and so as to server as a place marker, if necessary, for the user or student in his or her progression through the materials.

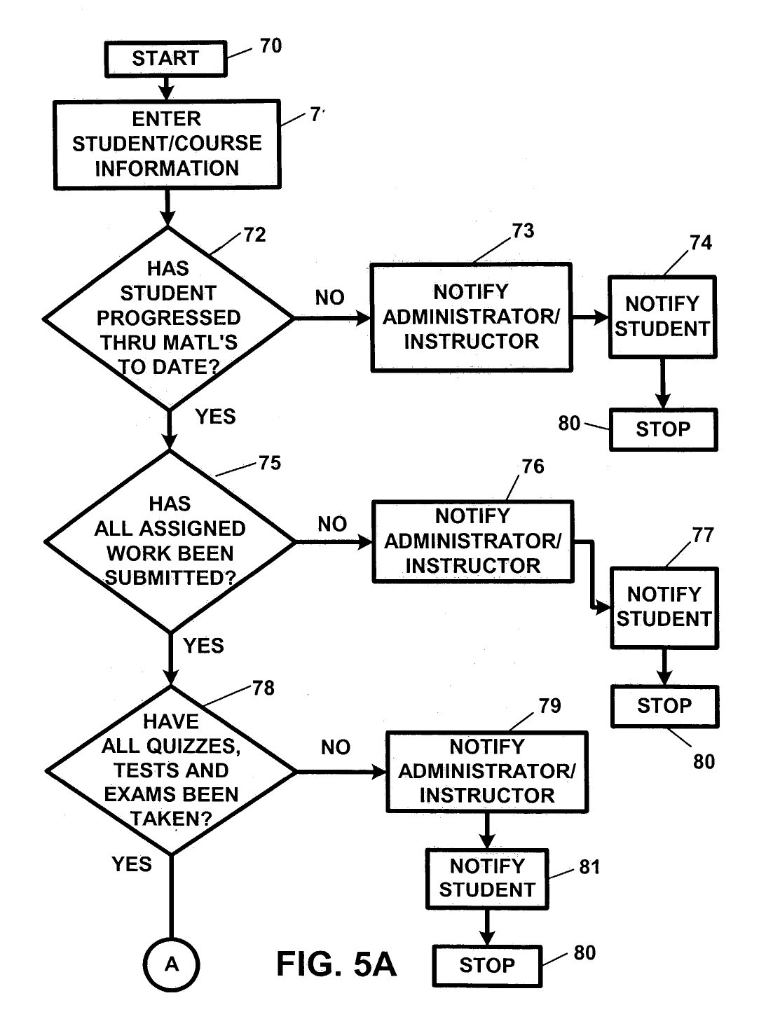

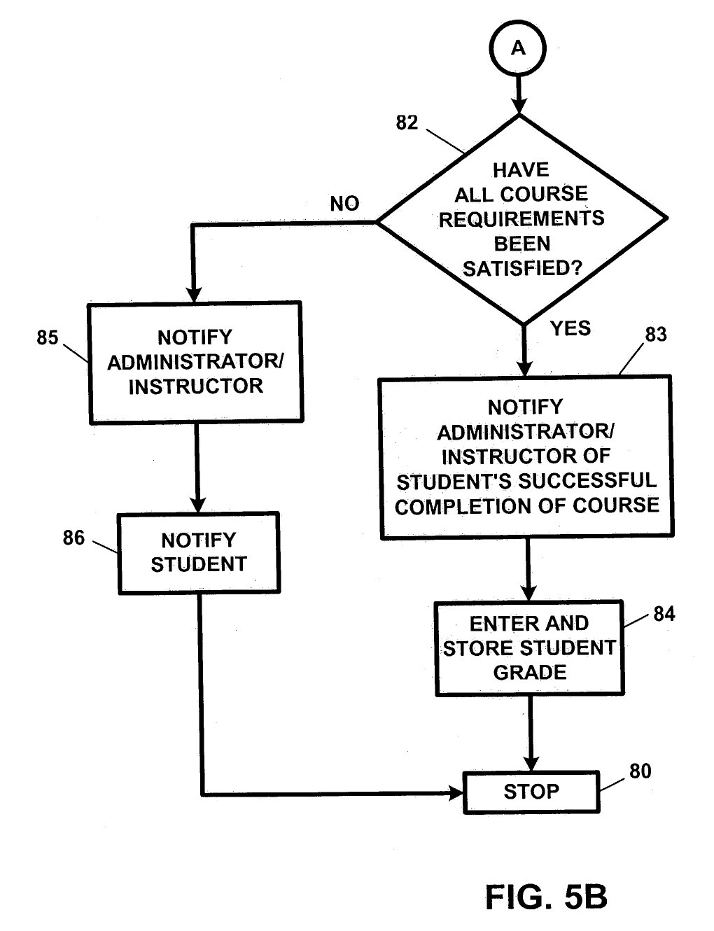

The apparatus 100 of the present invention can also be utilized to perform course administration. FIGS. 5A and SB illustrate a flow diagram illustrating a preferred embodiment operation of the apparatus 100 of the present invention as it is utilized to perform and/or to provide course management and/or administrative functions. The operation of the apparatus 100 in the administrative and/or course management mode commences at step 70 when it is desired to enter said mode of operation.

At step 71, the administrator or instructor will enter information indicative of the user's or student's identification and the course identification. The central processing computer 10 will then perform a test, at step 72, in order to determine if the student has viewed and/or has progressed through the lecture and/or course materials to date. If the student has not progressed through the course materials to date, the central processing computer 10, at step 73, will issue a notice to the administrator and/or instructor to that effect.

The central processing computer 10 will also issue a notice to the student, at step 74, over the network to the user's or student's remote user device 30, which notice could be in the form of an electronic message (e-mail), which may be immediately available to the user or student while the user or student is accessing the apparatus 100 and/or upon the user's or student's next accessing and/or signing onto the apparatus 100. This notice will alert the administrator, the instructor, if necessary, and the user or student, that the user or student is not up to date, and/or current, with viewing the lectures and/or the course materials. Thereafter, the apparatus 100 will cease operation at step 80.

The central processing computer 10, as described above, will record and store the user's or student's progression through the coursework. If the user or student is determined to be current with the coursework, at step 72, the central processing computer 10 will proceed to step 75, and determine if all of the assigned assignments, papers, reports, research assignments, homework assignments, etc., have been submitted by the user or student. As noted above, various assignments, papers, etc., can be transmitted to the central processing computer 10 via the network, such as by fax/modem and/or by e-mail. Quizzes, texts and examinations may also be administered on-line via the remote user device. The central processing computer 10 will record receipt of these submissions and store all data and/or information pertinent thereto. The assignments and/or papers may also be sent in hard copy form, by the user or student, to a designated location, office and/or individual, with the submission and receipt thereof being noted and recorded by a designated location, office and/or individual.

If the user or student has not submitted all of the required and/or assigned assignments, the central processing computer 10 will issue a notice to the administrator and/or instructor at step 76. The central processing computer 10 will also issue a notice to the student, at step 77, over the network to the student's remote user device 30, which notice could be in the form of an electronic message (e-mail) while the student is using the remote user device 30 and/or which would be available upon the user's or student's next accessing and/or signing onto the apparatus 100. This notice will alert the administrator, the instructor, if necessary, and the user or student, that the user or student is not up to date and/or current with submitting the required and/or assigned assignments. Thereafter, the apparatus 100 will cease operation at step 80.

Records of the users's or student's submission(s) will be stored on the central processing computer 10. If the user or student is up to date and/or current with submitting all of the assignments and/or papers, including having taken all quizzes, tests and or examinations, then the central processing computer 10 will proceed to step 78 and determine if the user or student has taken and submitted all of the quizzes and tests and/or examinations which were, or had been, administered to date.

If the user or student has not taken and/or submitted all of the required quizzes, tests and/or examination, the central processing computer 10 will, at step 79, issue a notice to the administrator and/or instructor. The central processing computer 10 will also issue a notice to the student, at step 81, over the network to the user's or student's remote user device 30, which notice could be in the form of an electronic message (e-mail) which could be available to the user or student while they are using the remote user device 30 and/or upon the user's or student's next accessing, and/or signing onto, the apparatus 100. This notice will alert the administrator, the instructor, if necessary, and the user or student that the user or student has not taken and/or submitted all of the quizzes, tests and/or examinations which have been administered to date. Thereafter, the apparatus 100 will cease operation at step 80.

If the user or student is up to date and/or current with submitting all quizzes, tests and/or examinations, the central processing computer 10 will proceed, to step 82, in order to determine if the course and/or course requirements have been completed by the user or student. If a prespecified course completion date has been reached and if the user or student has met all of the course requirements, then the central processing computer 10 will, at step 83, issue a signal signifying to the administrator, the instructor that the user or student has successfully completed the course. The administrator and/or instructor may then enter a final grade for the student and the course completion and/or grade will be stored in an appropriate database at step 84. Therefore, the apparatus 100 will cease operation at step 80. If, however, it is determined that the user or student has not fulfilled all of the course requirements, then the central processing computer 10 will, at step 85, issue a notice to the administrator and/or instructor.

The central processing computer 10 will also issue a notice to the user or student, at step 86, over the network to the user's or student's remote user device 30, which notice could be in the form of an electronic message (e-mail) while the student is using the remote user device and/or upon the user's or student's next accessing and/or signing on to the apparatus 100. Therefore notices will alert the administrator, the instructor, if necessary, and the user or student, that the user or student has not fulfilled the course requirements. The user or student may also be prompted to fulfill the requirements and/or to drop the course. The student may then take the appropriate steps to complete the course requirements and/or to drop the course. Thereafter, the apparatus 100 will cease operation at step 80.

In another preferred embodiment, the central processing computer 10 may prompt the user or student so as to ascertain the user's or student's intended course of action (i.e. whether the student intends to complete the course or drop the course). The central processing computer 10, upon receiving the user's or student's response, may determine what intended course of action the user or student has chosen. If it is determined that the user or student has decided to drop the course, the central processing computer 10 will record and store this decision in the appropriate database and/or in the student's records. The central processing computer 10 will then cease operation until activated at a later time. If, on the other hand, it is determined that the user or student desires to fulfill the course requirements, within pre-established course and/or institution guidelines, the central processing computer 10 will keep the user's or student's registration and/or account active.

In the above-described manner, the present invention provides an apparatus and a method for administering the presentation of course and/or instructional materials and the user's and/or student's fulfillment of course requirements in an educational and/or an instructional environment.

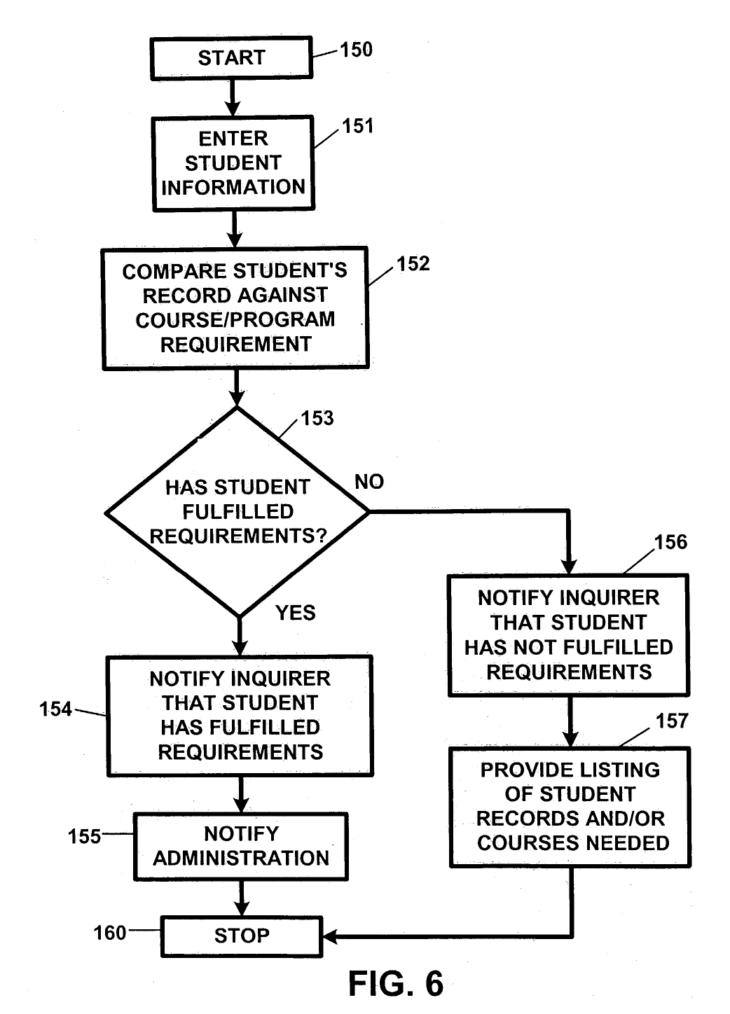

The apparatus and method of the present invention can also be utilized so as to administer and/or monitor a user's and/or a student's progress through a degree program, a certificate program, a continuing education program and/or other educational or similar environment (hereinafter “program administration mode”.). FIG. 6 illustrates a flow diagram of the operation of the apparatus 100 in administering a program of study. In FIG. 6, the operation of the apparatus in the program administration mode commences at step 100 at which time, the apparatus 100 may be accessed by any individual, including an administrator(s), an instructor(s), support staff/personnel, and/or by the user or student, and/or by any other authorized individual with an interest in the user's or student's progress.

The individual may access the apparatus through either the remote user device, a server computer interface device and/or via any other suitable device. At step 101, the individual will enter data and/or information regarding the student. The student's course of study and/or program will be stored in the appropriate database upon the student's registration with the institution. Upon the successful completion of course(s), the central processing computer 10 will update a user's or student's file record so as to maintain a list of courses which the user or student has currently completed.

At step 102, the central processing computer 10 will compare the student's file record against the degree program and/or other program requirements for the degree program and/or other program in which the user or student is registered. The central processing computer 10, at step 103 will then perform a test in order to determine if the student has fulfilled all of the degree program and/or other program requirements. If the student has fulfilled all of the requirements, the central processing computer 10 will, at step 104, notify the individual that the user or student has successfully completed the program requirements.

The central processing computer 10, at step 105, may also notify the administration so that the student will be issued a corresponding diploma, certificate and/or other appropriate documentation. Thereafter, operation of the apparatus 100 will cease at step 110. If, at step 103, the central processing computer 10 determines that the student has not fulfilled the program requirements, the central processing computer 10 will, at step 106, notify the individual of same. The central processing computer 10, may then, at step 107, provide the individual with a complete and/or partial list of the course and/or courses successfully completed by the user or student and/or a complete and/or partial list of the course and/or courses which have yet, to be successfully completed by the student. Thereafter, the central processing computer 10 will cease operation at step 110.

In yet another preferred embodiment of the present invention the apparatus 1 may provide announcements and/or communicate with the student at times and/or locations when and where the student is not connected to the central processing computer 10. In this regard, the apparatus 1 may be utilized so as to communicate with the student such as, for example, by notifying the student of administrative-related and/or course-related announcements, course scheduling information, testing information, assignment information, registration information and/or any other information related to the course and/or program of study.

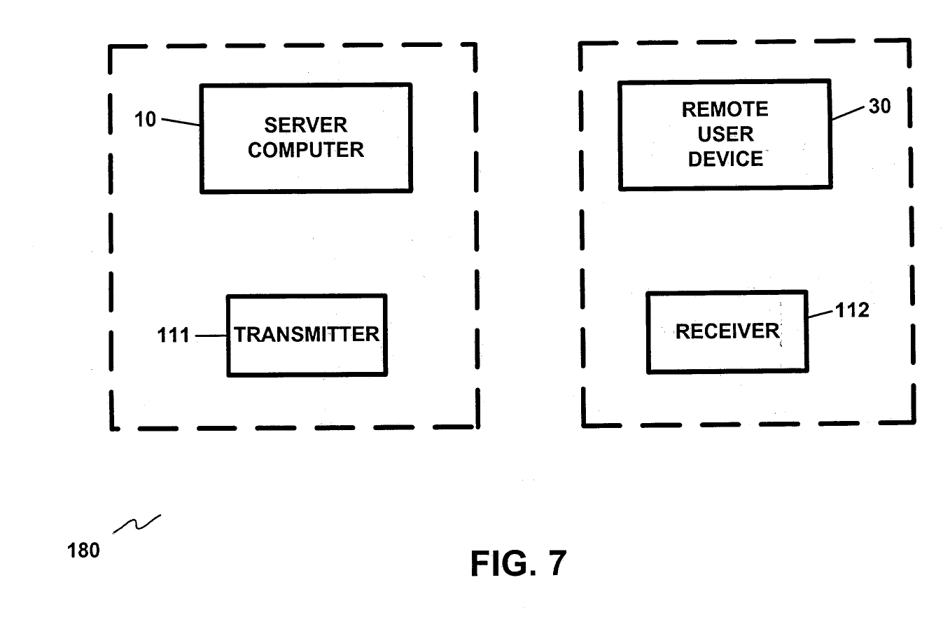

FIG. 7 illustrates another preferred embodiment of the present invention wherein the apparatus designated by reference numeral 150 further includes and/or has associated therewith a transmitter 111, which is connected to the central processing computer 10 and which is utilized to transmit signals from the institution to the student. The apparatus 150 further includes a receiver 112 which is a remote receiver which is associated with a respective remote user device 30, for receiving the signals which are transmitted by the transmitter 111.

In the embodiment of FIG. 7, the receiver is a telephone beeper or pager or any other suitable wireless communication device for receiving signals transmitted over an appropriate communications network or medium. The receiver 112 may also be of the non-wireless variety, if desired. The receiver 112 may or may not be located at the remote user device 30 or it can be located at any other appropriate location, including the user's or student's person, such as a beeper or paging device, so as to provides an apparatus for communication with the user or student at any time and at any location.

At any time during the student's enrollment with the educational institution, and/or during the course presentation, the student can be notified of course developments and/or notices by the apparatus 150. The apparatus 150, via transmitter 111 will transmit a signal to the student's receiver 112 thereby notifying the student of the development and/or notice. The apparatus 150 may also transmit an e-mail message to the remote user device 30 of the student.

In the above manner, the apparatus and method of the present invention may be utilized to provide educational and/or instructional services for individuals and/or groups of individuals in conjunction with an on-line service, and/or on, or over, the Internet and/or the World Wide Web and/or any other suitable communication network or environment. The apparatus and method of the present invention enables an individual or group of individuals to matriculate in a degree program, a certificate program, a continuing education program, and/or engage in any other programs of study, at their own pace and from a location remote from the educational institution.

In any and/or all of the embodiments described herein, any of the instructors, educators, and/or administrators, can have remote user devices associated therewith for use in conjunction with the apparatus 100.

In any and/or all of the embodiments described herein, the apparatus 100 can be utilized to provide video conferencing by and between any of the instructors, educators, administrators and students, and/or any other parties. The present invention can provide video conferencing between any number of individuals. For example, a group of students can meet in a virtual meeting environment to study together exchange ideas, perform group projects and/or can meet for any other information. The students can exchange ideas orally as well as visually, can transmit copies of notes, graphical study information and/or any other information which can or may be exchanged by students in their study efforts. Each remote user device 30 can be provided with the capability of displaying the images of any number of individuals in split screen video format.

The apparatus and method of the present invention can provide video conferencing, in a manner similar to that described above, by and between instructors, educators, and/or administrators and a student or group of students for providing instruction, group instruction, to provide tutoring, to offer help or assistance, to provide counseling, to provide career counseling, and/or to provide any other services and/or assistance to the students.

In the above described manner, the apparatus 100 and method of the present invention can provide all of the services amenities of an educational institution in a virtual environment and/or in a distance learning environment.

In any and/or all of the embodiments described herein the central computer system 10, the central processing computer 10 and/or the central processing computer 10, whichever the application requires and/or calls for, can provide in, its respective database 19, various course or program requirements for any and/or all of the various programs and/or educational institutions offering courses and/or programs of study via the present invention. The database 19 can also provide alternate, equivalent and/or substitute lectures, course-segments, and/or other educational and/or instructional materials which are approved to be equivalent to and/or which can be substituted for any of the respective lectures, course segments, and/or other educational and/or instructional materials, offered by an institution.

The student may at any time access and view and/or otherwise participate in any of these alternate and/or substitute lectures, course segments, and/or other educational and/or instructional materials during the course or program of study for which he or she is currently enrolled. For example, a student taking a course can substitute a lecture on a particular topic with an equivalently deemed lecture from another course offered by the student's educational institution and/or another educational institution. In this manner, the student of students can partake in obtaining and/or participating in lectures, course segments and/or other educational and/or instructional materials offered by other instructors and/or other educational institutions while not interrupting his or her studies and/or current courses and/or programs. In this manner, the present invention can also provide for a more versatile courses and/or program offerings.

In any and/or all of the embodiments described herein, the present invention, in a manner similar to that described above, can offer alternatives, equivalents and/or substitutes for any complete courses which can be accepted for transfer credit by the student's educational institution. The database 19 can store any and/or all information regarding the educational institutions, the courses offered thereby, the courses of other educational institutions for which transfer credits will be accepted as well as any other information needed and or desired for providing and/or for facilitating these services.

In any and/or all of the embodiments described herein, the apparatus 100 can provide notification services to students when a specific course or lecture, whether acceptable for transfer credit, or as an equivalent or substitute lecture, or not, may be offered by a particular educational institution or by a particular professor or educator. The student can enter his or her request to receive notification for a course or lecture via the respective remote user device 30 into the respective central computer system 10, central processing computer 10, and/or central processing computer 10. The student's request as to course, course topic, course description, educational institution, professor, etc., as well as any student contact information (i.e. e-mail address, phone number, mailing address, beeper or pager number, or any other contact information), can then be stored in the database 19.

Upon the receipt of the request and/or the offering of a new course or lecture, the CPU 11 of the server computer will query the database 19 in order to determine if a requested course or lecture is being offered. If a match for the student's request is found, the central processing computer 10 will generate an appropriate electronic message and transmit same to a communication device, as a remote user device 30, beeper, pager, telephone, etc., which is associated with the student. For example, a student enrolled in a certain major, may desire to take a course or hear a lecture offered by a prominent professor from a different educational institution. Whether or not acceptable for transfer credit and/or as a lecture substitute, the individual can request to be notified when that prominent professor offers a desired course or lecture. Once the central processing computer 10 processes the student's request and ascertains that the requested course of lecture is being offered, the central processing computer 10 can notify the student, and the student can register for the course and/or request receipt of the lecture.

In the above-described manner, the apparatus and method of the present invention can facilitate distance learning by a student or students at different educational institutions and/or with different instructors during a course, a course of study, and/or a program of study. The present invention can also provide for a distance learning environment wherein the student may choose from a large variety and/or selection of courses, lectures and/or programs, from any number and/or types of educational institutions, training facilities and/or schools.

In any and/or all of the embodiments described herein, the apparatus 100 and method of the present invention, via the central computer system 10, the central processing computer 10, and/or the central processing computer 10, whichever the application calls for, can facilitate any and/or all student registration for any and/or all of the courses, lectures, educational and/or instructional segments and/or any and/or all of the educational and/or instructional materials, provided by and/or via the apparatus 100. The apparatus 100 can also provide all record keeping functions regarding any and/or all use of the present invention by any of the respective educators, instructors, administrators and student who utilize the present invention.

In any and/or all of the embodiments described herein, the apparatus 100 can administer financial accounts for any of the educational institutions, students, instructors, administrators, and or other users of the present invention. In this regard, the central processing computer 10 can administer financial accounts, effect financial transfers between the respective accounts of the respective parties, provide accounting services for the respective parties and/or accounts, and/or provide notification of financial account activity, for any of the respective accounts and/or respective parties. The central processing computer 10 can effect payments from accounts, such as from a student's account, such as for a tuition payment, and effect deposits to an account, such as to an account for an educational institution.

The apparatus 100 of the present invention can also provide e-mail services for the various instructors, educators, administrators and student who utilize the present invention, in order for allowing any of the above parties to communicate with each other.

The present invention may also enable individuals to enroll in, to participate in, and to partake in, continuing education courses and/or programs, at any time and from any location and enables them to study at a plurality of institutions at the same time.

The present invention may also enable individuals to obtain information as to whether equivalent and/or substitute or alternate courses, which may be offered at institutions other than the institution at which the user or student is enrolled, will be accepted for transfer credit.

The present invention may also be utilized so that a user or student may search for specific and/or general course or courses of interest to him or her among the many courses which could be provided by the many institutions which may operate in the communications network associated with the present invention so as to enable the user or student to locate and register with the course or courses with any institution regardless of its location relative to the user or student. Appropriate attendance files and/or database information and/or data regarding the user's or student's coursework or studies may be maintained for use in any appropriate manner.

The present invention provides an apparatus and a method for allowing an individual or groups of individuals to enroll in and/or partake of educational and/or instructional courses and programs, at their own pace, while allowing these individuals to progress through courses and/or instructional sessions. The present invention also provides and apparatus and a method for providing administration and/or oversight over individuals in educational and/or instructional programs.

The present invention can be utilized in conjunction with distance learning and on-line educational and/or instructional programs, employee training programs, job training programs, vocational programs, continuing education programs, as well as in any other instances where an individual and/or individuals may simply want to enroll in courses for personal enjoyment, interest and/or professional growth.

In another preferred embodiment, the apparatus 100 can administer and/or manage financial accounts for any one or more of the respective educational institutions, students, individuals, administrators, instructor, and/or educators described herein. In this preferred embodiment, the central processing computers 10 and the remote user devices 30 can be linked to, and/or have associated therewith, financial accounts. In this regard, the respective operating software utilized in the respective central processing computer 10 and/or remote user devices 30 can administer the respective financial accounts associated with the respective party. The central processing computer 10 and/or any of the remote user devices 30 can effect payments to, and/or receive payments from, any other financial account administered and/or managed by the apparatus 100. The central processing computer 10 and/or any of the remote user devices 30 can also effect and/or receive wire transfers, credit card payments, charge card payments, debit card payments and/or electronic money, digital cash and/or any other form of electronic or digital payment.

The central processing computer 10 and/or any of the remote user devices 30 can also generate a notification and/or transaction report upon the occurrence and/or completion of any financial transaction and generate and transmit a report to any of the parties or individuals involved.

In another preferred embodiment, the apparatus 100 can be utilized in conjunction with search engines and/or with a meta search engine(s) in order to locate or find courses, educational institutions, research, instructors, experts, tutors, and/or services and/or products related to any of the educational services and/or products described herein and/or related thereto.

In any and/or all of the embodiments described herein, the apparatus and method of the present invention can utilize and/or can be used in conjunction with Group chat rooms and/or private chat rooms which can be utilized by any of the students, instructors and/or administrators described herein, during an educational and/or an instructional session and/or at any other time.

In another preferred embodiment, as well as in any of the embodiments described herein, intelligent agents, software agents, mobile agents, and/or related technologies, can be utilized in conjunction with the present invention. The respective intelligent agent(s), software agent(s), mobile agent(s), (hereinafter referred to collectively as “intelligent agent” or “intelligent agents”) can be programmed and/or designed to act on behalf of the respective users, students, educational institutions, administrators, instructors, and/or any other parties who or which utilize the present invention.

The intelligent agent can act on behalf of the respective party or parties in various related transactions, interactions, and/or other activities, which are described as being performed herein and/or which may be incidental to and/or which may be related thereto. Therefore, the present invention also provides an agent-based apparatus and method for effectuating an affiliated marketing relationship.

Applicant hereby incorporates by reference herein the subject matter of the Agent Sourcebook, A Complete Guide to Desktop, Internet and Intranet Agents, by Alper Caglayan and Colin Harrison, Wiley Computer Publishing, 1997. Applicant also incorporates by reference herein the subject matter of Cool Intelligent Agents For The Net, by Leslie L. Lesnick with Ralph E. Moore, IDG Books Worldwide, Inc. 1997.

While the present invention has been described and illustrated in various preferred embodiments, such descriptions are merely illustrative of the present invention and are not to be construed to be limitations thereof. In this regard, the present invention encompasses all modification, variations and/or alternate embodiments with the scope of the present invention being limited only by the claims which follow.

What is claimed is:

1. An apparatus for providing educational material in a network environment, comprising:
a processing device for processing a request from an individual to receive educational material, wherein the educational material is at least one of video material, audio material, and video and audio material, wherein the processing device is capable of processing information regarding the individual's progression through at least one of a course of study and a program of study;
a memory device for storing educational material and information regarding at least one of a course of study, a program of study, and an individual's progression through at least one of a course of study and a program of study:
a transmitter for transmitting the educational material to a communication device associated with the individual in response to the request to receive the educational material, wherein the transmitter is controlled by the processing device; and
a receiver for receiving a transmission termination signal from the communication device associated with the individual,
wherein the processing device terminates the transmission of the educational material in response to the termination signal, and further wherein the processing device at least one of identifies, records, and stores, information regarding a first location, wherein the first location is the location in the educational material where the transmission of the educational material is terminated, and further wherein a subsequent transmission of the educational material to the communication device commences from a second location which is located prior to the first location in the educational material, and further wherein the subsequent transmission of the educational material includes a transmission of at least a portion of the educational material previously transmitted to the communication device.

2. The apparatus of claim 1, wherein the education material is at least one of encoded, marked, digitally encoded, analog encoded, digitally marked, analog marked, time-marked, time-stamped, and frame numbered, and further wherein the processing device processes the first location in conjunction with an amount of educational material review to generate the second location.

3. The apparatus of claim 1, wherein the memory device is linked to one of a computer system, a database, a data source, and an educational information source, textbook information, located external from the apparatus.

4. The apparatus of claim 1, wherein the transmitter transmits at least one of an announcement, an update, and information, to the communication device associated with the individual, wherein the at least one of an announcement, an update, and information, contains at least one of educational material, administrative material, testing material, registration material, scheduling material, course material, and program material.

5. The apparatus of claim 1, wherein the communication device associated with the individual is a wireless communication device.

6. The apparatus of claim 1, wherein the educational material is provided on the communication device in a split-screen format.

7. The apparatus of claim 1, wherein the educational materials includes a table of contents or syllabus regarding a course.

8. The apparatus of claim 1, wherein the processing device processes information regarding the individual to determine whether the individual is a valid student.

9. The apparatus of claim 1, wherein the processing device processes information regarding the individual's enrollment in classes at a plurality of institutions.

10. The apparatus of claim 1, wherein the processing device processes information on-line testing.

11. The apparatus of claim 1, wherein the processing device processes information regarding whether the individual has progressed through a lecture.

12. The apparatus of claim 1, wherein the processing device processes information regarding whether the individual has progressed through at least one of a degree program, a certificate program, and a continuing education program.

13. The apparatus of claim 1, wherein the apparatus provides video conferencing by and between at least one of an instructor, an educator, an administrator, and a student and the individual.

14. The apparatus of claim 1, wherein the processing device processes information regarding the individual's registration in a course of study of a program of study.

15. The apparatus of claim 1, wherein the processing device processes information regarding an administration of a financial account for at least one of the individual, an instructor, and an educational institution.

16. The apparatus of claim 1, wherein said transmitter transmits educational material containing at least two of multimedia information, audio information, video information, graphical information, text information, and a live broadcast, simultaneously.

17. The apparatus of claim 1, further comprising:
an input device for entering information concerning an update in the individuals one of status and progression related to at least one of a course of study and a program of study, wherein the processing device processes the information and stores the information in the memory device.

18. The apparatus of claim 1, wherein the processing device generates a notification signal containing information regarding at least one a course, a lecture, a program, and an information update regarding same, and further wherein the transmitter transmits the notification signal to at least one of the communication device associated with the individual and a second communication device associated with the individual.

19. An apparatus for providing educational material in a network environment, comprising:
a processing device for processing a request from an individual to receive educational material, wherein the educational material is at least one of video material, audio material, and video and audio material, wherein the processing device is capable of processing information regarding the individual's progression through at least one of a course of study and a program of study;
a memory device for storing educational material and information regarding at least one of a course of study, a program of study, and an individuals progression through at least one of a course of study and a program of study:
a transmitter for transmitting the educational material to a communication device associated with the individual in response to the request to receive the educational material, wherein the transmitter is controlled by the processing device; and
a receiver for receiving a transmission termination signal from the communication device associated with the individual,
wherein the processing device terminates the transmission of the educational material in response to the termination signal, and further wherein the processing device at least one of identifies, records, and stores, information regarding a first location, wherein the first location is the location in the educational material where the transmission of the educational material is terminated, and further wherein a subsequent transmission of the educational material to the communication device commences from a second location which is located prior to the first location in the educational material, and further wherein the subsequent transmission of the educational material includes a transmission of at least a portion of the educational material previously transmitted to the communication device, and further wherein the apparatus is utilized on or over at least one of the Internet and the World Wide Web.

20. An apparatus for providing educational material in a network environment, comprising:
a processing device for processing a request from an individual to receive educational material, wherein the educational material is at least one of video material, audio material, and video and audio material, wherein the processing device is capable of processing information for registering the individual in a course of study, and further wherein the processing device is capable of processing information regarding the individual's progression through at least one of a course of study and a program of study;
a memory device for storing educational material and information regarding at least one of a course of study, a program of study, and an individual's progression through at least one of a course of study and a program of study:
a transmitter for transmitting the educational material to a communication device associated with the individual in response to the request to receive the educational material, wherein the transmitter is controlled by the processing device; and
a receiver for receiving a transmission termination signal from the communication device associated with the individual,
wherein the processing device terminates the transmission of the educational material in response to the termination signal, and further wherein the processing device at least one of identifies, records, and stores, information regarding a first location, wherein the first location is the location in the educational material where the transmission of the educational material is terminated, and further wherein a subsequent transmission of the educational material to the communication device commences from a second location which is located prior to the first location in the educational material, and further wherein the subsequent transmission of the educational material includes a transmission of at least a portion of the educational material previously transmitted to the communication device, and further wherein the apparatus is utilized on or over at least one of the Internet and the World Wide Web.
